(19) United States
(12) Patent Application Publication
(10) Pub. No.: US 2011/0320650 A1
(43) Pub. Date: Dec. 29, 2011

(54) ANALYSIS PREPROCESSING SYSTEM, ANALYSIS PREPROCESSING METHOD AND ANALYSIS PREPROCESSING PROGRAM

(75) Inventors: Kouji Kida, Tokyo (JP); Kenichiro Fujiyama, Tokyo (JP); Teruyuki Imai, Tokyo (JP); Nobutatsu Nakamura, Tokyo (JP)

(73) Assignee: NEC CORPORATION, Tokyo (JP)

(21) Appl. No.: 13/148,835

(22) PCT Filed: Feb. 19, 2010
(86) PCT No.: PCT/JP2010/001106

§ 371 Date: Aug. 10, 2011

(30) Foreign Application Priority Data
Feb. 20, 2009 (JP) 2009-038414

(51) Int. Cl. G06F 3/00

(52) U.S. Cl. 710/52

(57) ABSTRACT

An analysis preprocessing system is provided which is capable of rapidly passing data to means for analyzing data while preventing the data from overflowing, even if large amounts of data are transmitted from a large number of data generation sources. Data acquisition means 71 acquires a data group generated by the plurality of data generation sources. Data clipping means 72 clips each data from the data group acquired by the data acquisition means 71. Sampling means 73 samples part of the clipped data and stores the sampled data in a buffer 74. Analysis data determination means 75 determines an analysis data group which is a set of data used for analysis, from the data stored in the buffer 74.

### TECHNICAL FIELD

The present invention relates to an analysis preprocessing system, an analysis preprocessing method and an analysis preprocessing program that perform preprocessing on data targeted for data analysis.

### BACKGROUND ART

There is known a time series analyzing device that analyzes, in time series, data of logs or the like of a plurality of sensors and geographically distributed servers. In such a time series analyzing device, data targeted for analysis is temporarily stored as a database or a file and analyzed by batch processing or the like.

Such a database for accumulating data has been described in Non-patent Document 1. In a technology described in Non-patent Document 1, sensor data observed by a sensor network is accumulated in a single database on the network. For reference, a query is performed in SQL to refer to the data.

A description will be made of an example in which logs of apache (Apache Software Foundation) widely used as a Web server are analyzed. A plurality of Web servers are normally prepared to distribute access from clients. The respective Web servers independently store logs of access and errors as files. Upon setting the default of apache, error logs are recorded in a /usr/local/apachellogs/error.log file. When an analyzing device analyzes these logs, the analyzing device collects logs recorded in plural servers using an FTP (File Transfer Protocol) or the like to analyze the logs.

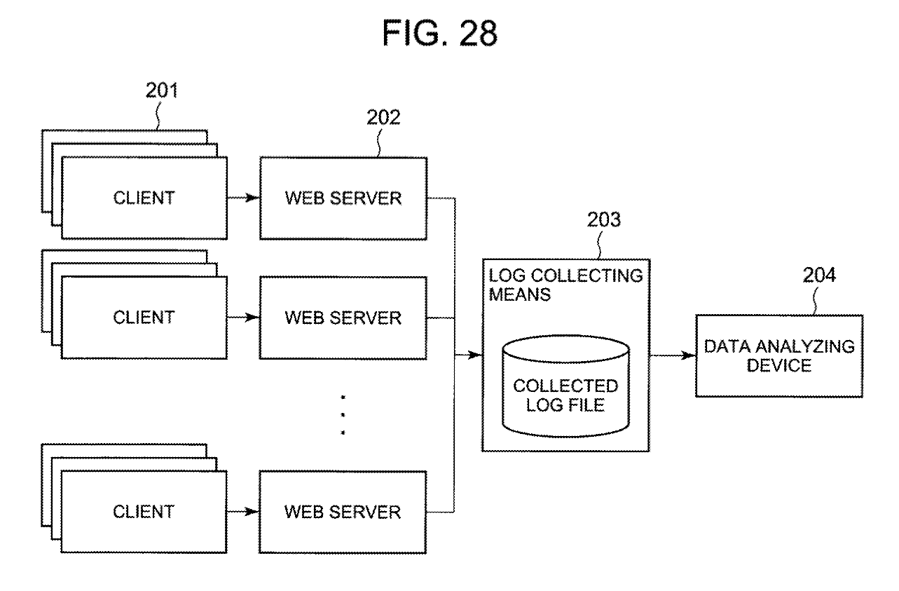

An example of a general configuration in which data to be analyzed is collected, is shown in FIG. 28. Respective Web servers 202 that serve as data generation sources are respectively accessed by clients 201 and generate data (logs). The Web servers 202 transmit the logs to a log collecting means 203. When receiving the data therein, the log collecting means 203 stores the data as a database or a file in a storing means. Then, the log collecting means 203 converts the data into data form for data analysis and passes it to a data analyzing device 204. The data analyzing device 204 performs a data analysis.

As a simple configuration for achieving a configuration in which data generation sources (the Web servers 202 in the example shown in FIG. 28) and a data analyzing device are respectively independently operated, there is mentioned a configuration in which generated data is stored as a database or file and the data analyzing device analyzes the data. In such a configuration that the data generation sources and the data analyzing device advance processing asynchronously while communicating with each other, both need to determine the presence or absence of a communication request from the other party. This leads to a complicated system. To avoid such a complicated operation, such a configuration that generated data is stored as a database or file, has been adopted.

A license-free library usable for a process for transmitting data from data generation sources, a process for receiving the data and a process for temporarily storing the received data, exists in large numbers. For example, an FTP server may be used when a file is transferred. An ODBC (Open Database Connectivity) driver may be used at a database. In terms of the ability to use such a library, such a configuration that the generated data is stored as the database or file has been adopted.

A configuration has been described in Patent Document 1 in which data measured by a plurality of sensors such as vibration sensors, pulse sensors, etc. is collected by a microcomputer, and the microcomputer outputs data to a PDA or the like. The microcomputer performs filtering processing aiming at eliminating a disturbance signal, accumulating processing in second/minute units, etc. on original data of a biological signal to thereby generate processed data. The microcomputer transmits the processed data to the PDA. It has been described in Patent Document 1 that when it is determined that no fluctuation occurs in measured data and a subject to be examined is in a state in which a biological signal is not yet to be measured, the operation of measuring the biological signal is awaited until a predetermined time elapses.

A process for suppressing an amount of data per unit time which is output by each sensor in a sensor network has been described in Patent Document 2. It has been specifically described that the interval of measurement of each sensor node is increased, observation information are transmitted collectively or deemed communications are done between the sensor node and its corresponding router node to thereby suppress the transmitted amount of data per unit time.

It has been described in a patent document 3 that when received data is received in the follow-on stream, the follow-on data stream is interrupted. It has also been described that filtering about a customer organization and a user organization is performed on a data stream.

A charged beam length measuring device has been described in Patent Document 4, which deletes measured data where the absolute value of a difference between first measured data and second measured data exceeds a predetermined value.

### CITATION LIST

### Patent Literature

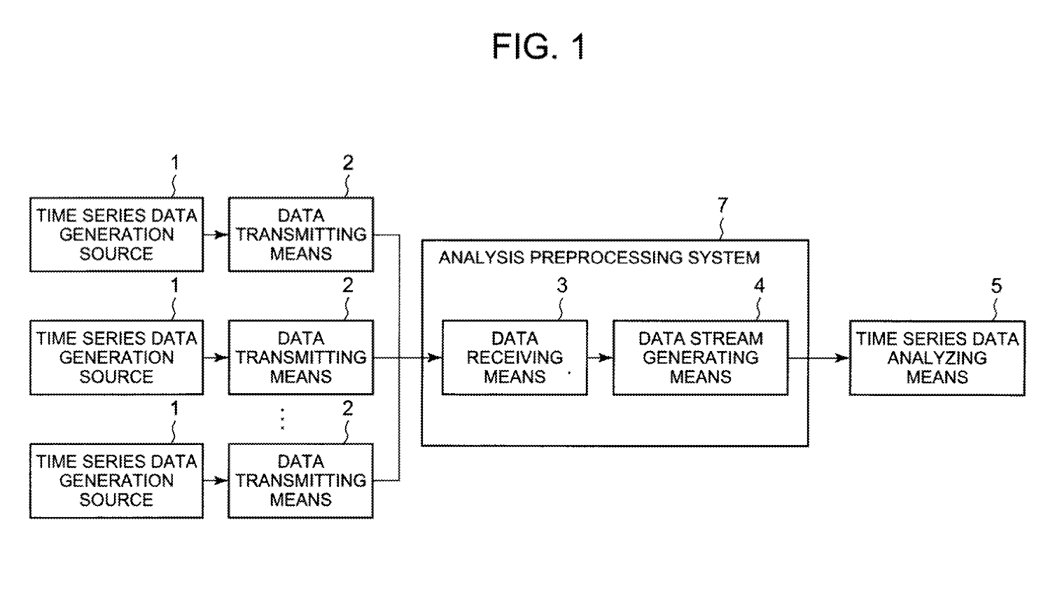

Patent Document 1 JP-A-2003-30775 (Paragraphs 0037, 0048-0050 and 0063, and FIG. 1)

Patent Document 2 JP-A-2008-42458 (Paragraph 0051)

Patent Document 3 JP-A-2002-77277 (Paragraphs 0033 and 0035)

Patent Document 4 JP-A-2002-62123 (Paragraph 0021)

### Non-Patent Literature

Non-patent Document 1 Yoh Shiraishi, “Database Technologies for Sensor Networks”, Information Processing, Information Processing Society of Japan, Vol. 47, No. 4 (20060415), pp. 387-393, 2006

### SUMMARY OF INVENTION

### Technical Problem

In a configuration (the configuration shown in FIG. 28, for example) in which a plurality of data generation sources such as sensors, Web servers or the like exist, and data thereof is temporarily stored as databases or files and passed to a data analyzing device, there is a possibility that when the number of the data generation sources increases, processing by means for collecting data will be insufficient due to the concentration of access to the means (the log collecting means 203 shown in FIG. 28, for example) for collecting the data. There is a possibility that when, for example, data is stored as a database or file, the processing of storing data and the like will be insufficient because I/O for data storage is low in speed.

When the number of data generation sources increases, the amount of data sent to the data collecting means (the log collecting means 203 shown in FIG. 28, for example) also increases and is therefore likely to exceed the storable capacity of data. It has been described in Patent Document 2 that the interval of measurement of each sensor node is increased, deemed communications are performed between the sensor node and the router node, and so on. It has been described in Patent Document 1 that the measurement by each sensor is awaited. It is however difficult to individually control the data generation sources as the number of the data generation sources such as the sensor nodes or the like, increases. When, for example, probe cars are assumed to be the data generation sources, giving instructions as to a waiting for data transmission and the like to tens of thousands of probe cars individually is difficult in terms of processing loads and so on.

The present invention therefore aims to provide an analysis preprocessing system, an analysis preprocessing method and an analysis preprocessing program capable of rapidly passing data to means for analyzing the data while preventing the data from overflowing, even if large amounts of data are transmitted from a large number of data generation sources.

### Solution to Problem

An analysis preprocessing system according to the present invention includes: data acquisition means which acquires a data group generated by a plurality of data generation sources; data clipping means which clips each data from the data group acquired by the data acquisition means; a buffer which stores data used for analysis; sampling means which samples part of the clipped data and stores the sampled data in the buffer; analysis data determination means which determines an analysis data group that is a set of the data used for analysis, from the data stored in the buffer; and analysis data output means which transmits the analysis data group to data analyzing means for analyzing data.

An analysis preprocessing method according to the present invention includes the steps of: acquiring a data group generated by a plurality of data generation sources; clipping each data from the acquired data group; sampling part of the clipped data and storing the sampled data in a buffer; determining an analysis data group which is a set of data used for analysis, from the data stored in the buffer; and transmitting the analysis data group to data analyzing means for analyzing data.

An analysis preprocessing program according to the present invention causes a computer to execute: data acquisition processing for acquiring a data group generated by a plurality of data generation sources; data clipping processing for clipping each data from the data group acquired by the data acquisition processing; sampling processing for sampling part of the clipped data and storing the sampled data in a buffer; analysis data determination processing for determining an analysis data group which is a set of data used for analysis, from the data stored in the buffer; and analysis data output processing for transmitting the analysis data group to data analyzing means for analyzing data.

### Advantageous Effect of the Invention

According to the present invention, it is possible to rapidly pass data to means for analyzing the data while preventing the data from overflowing even if large amounts of data are transmitted from a large number of data generation sources.

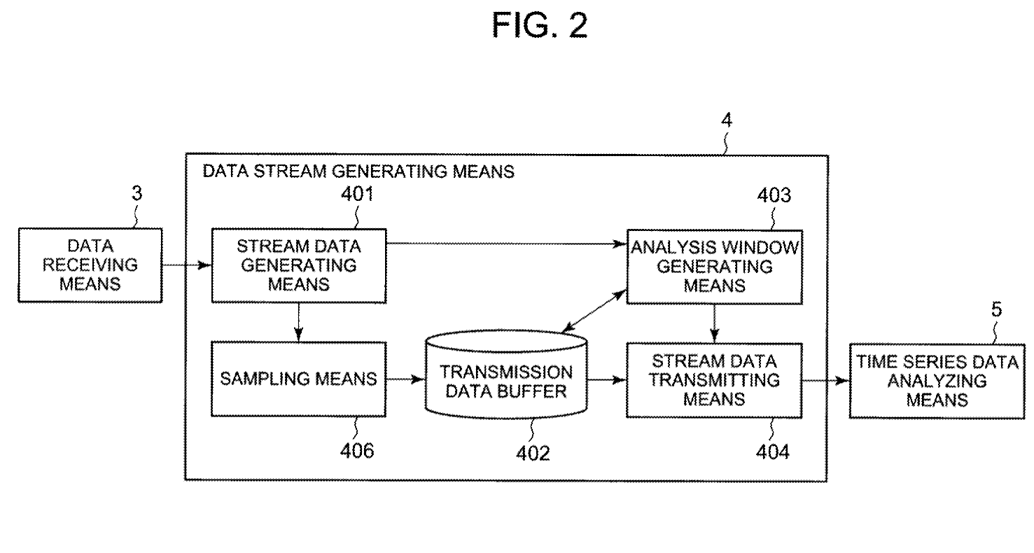

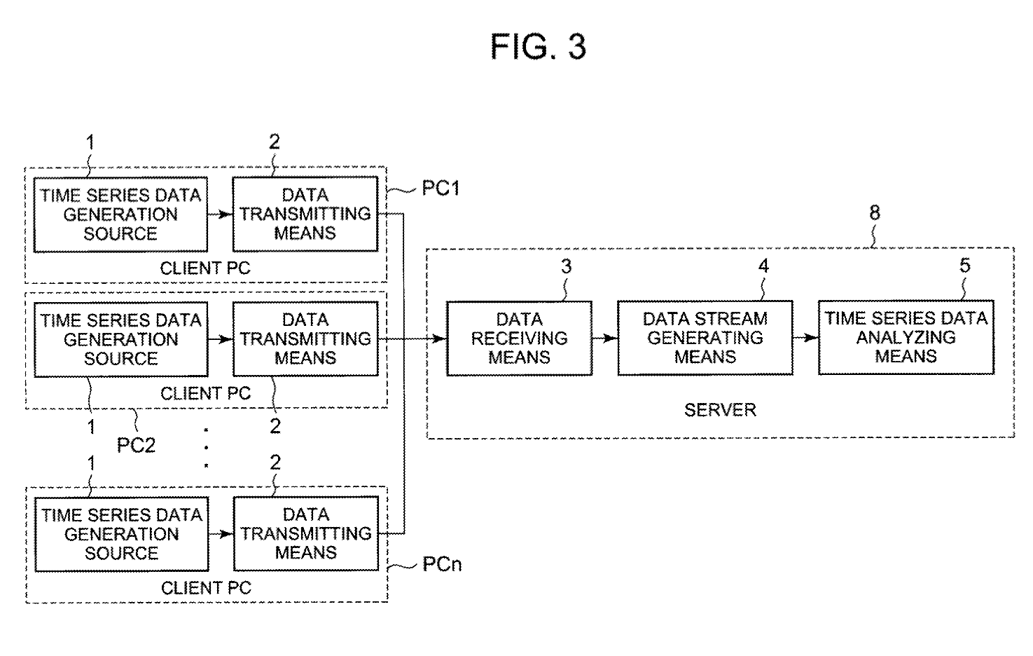

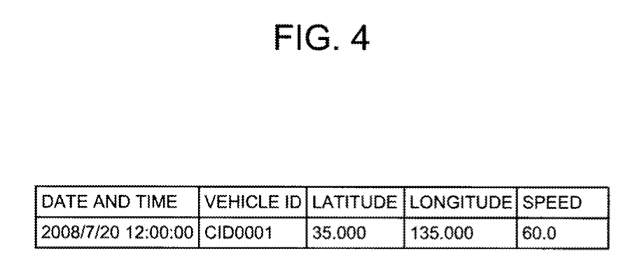

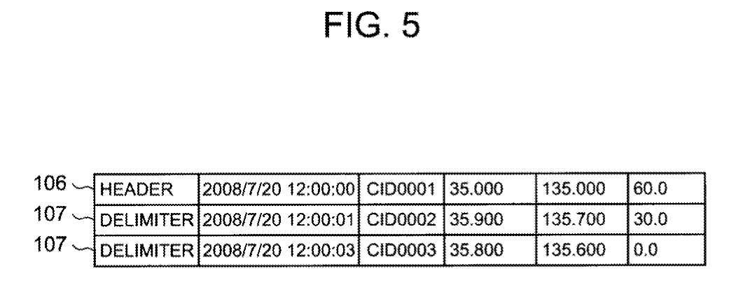

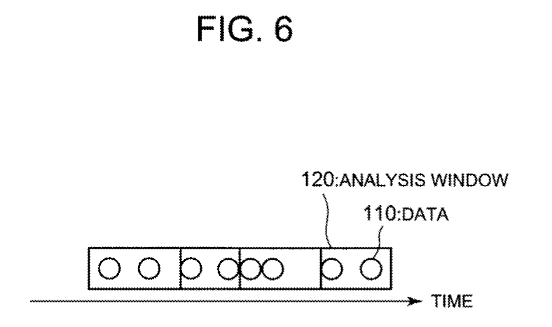

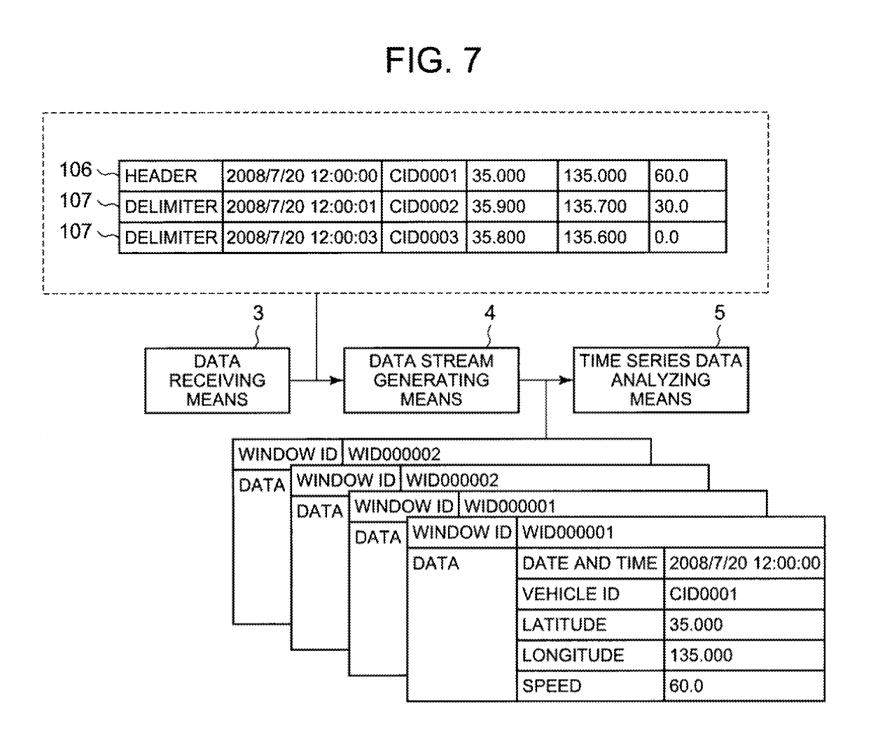

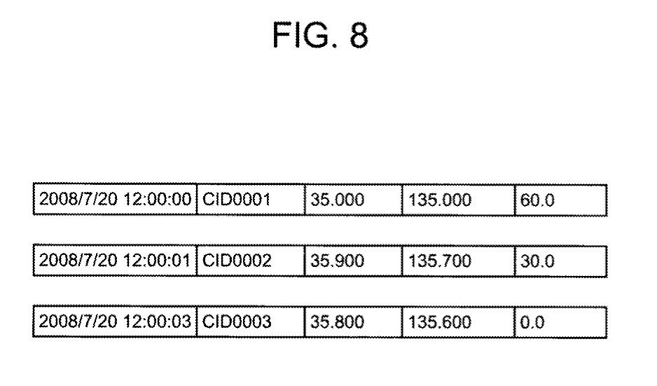

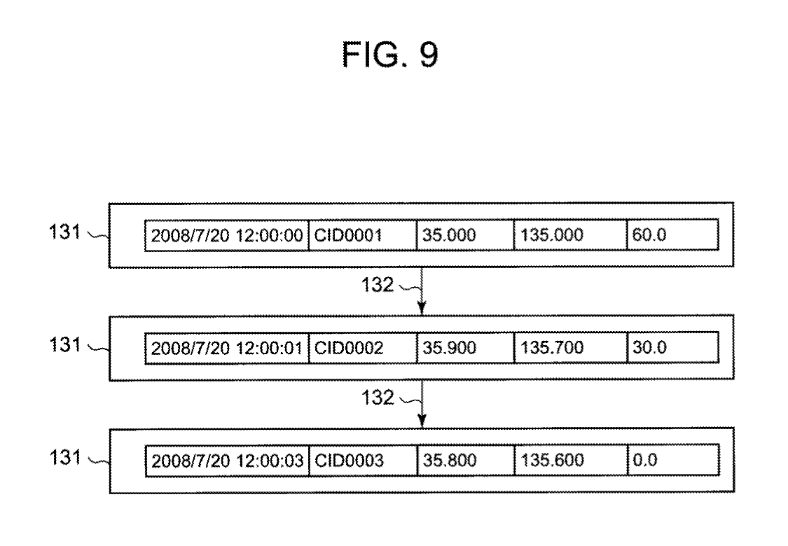

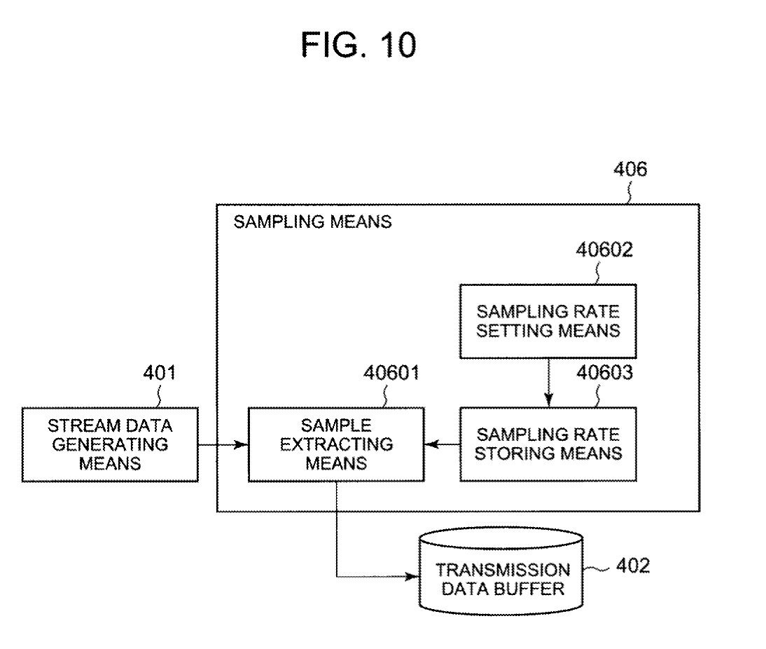

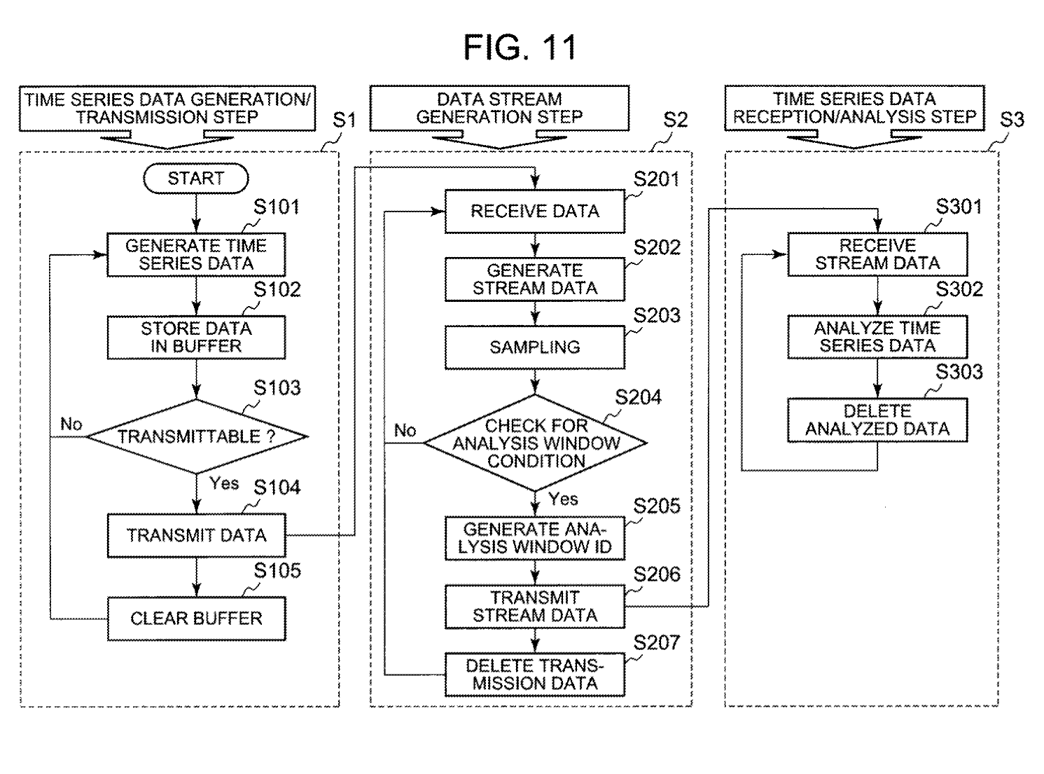

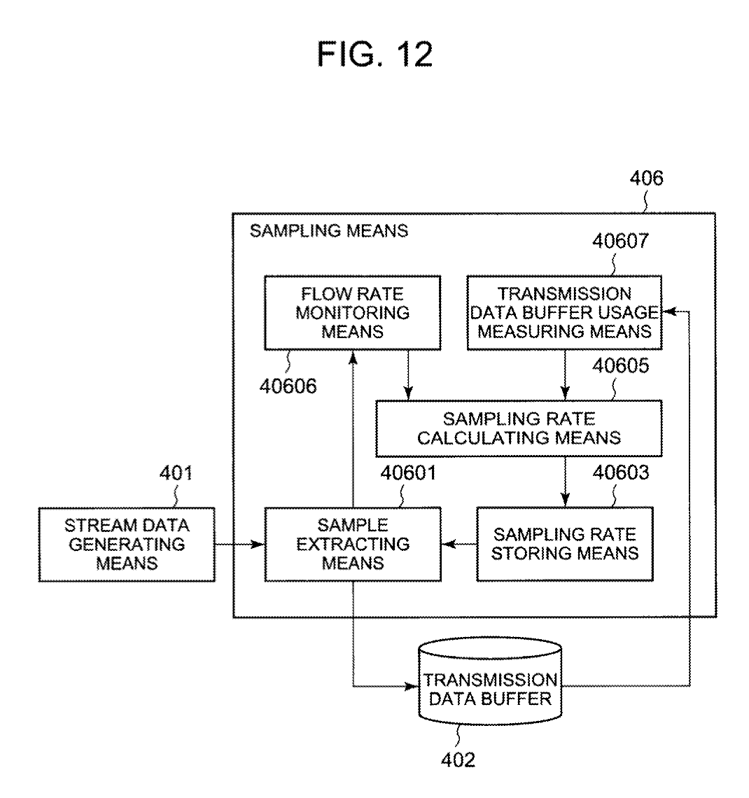

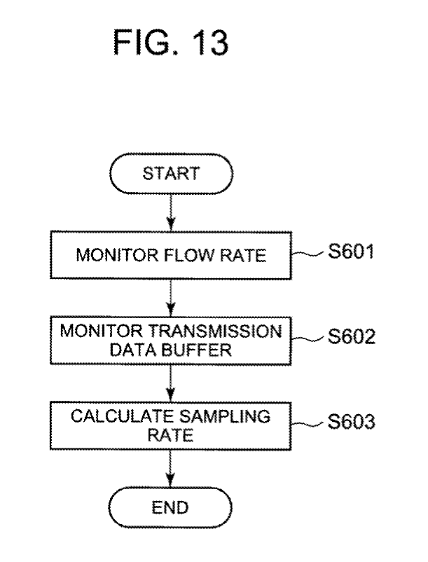

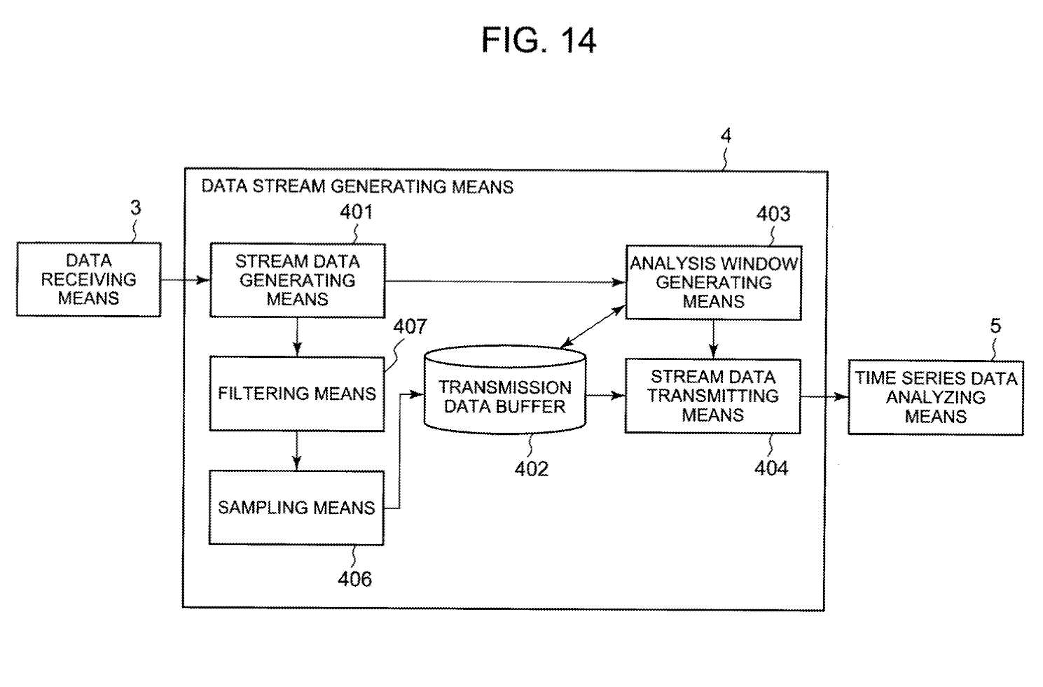

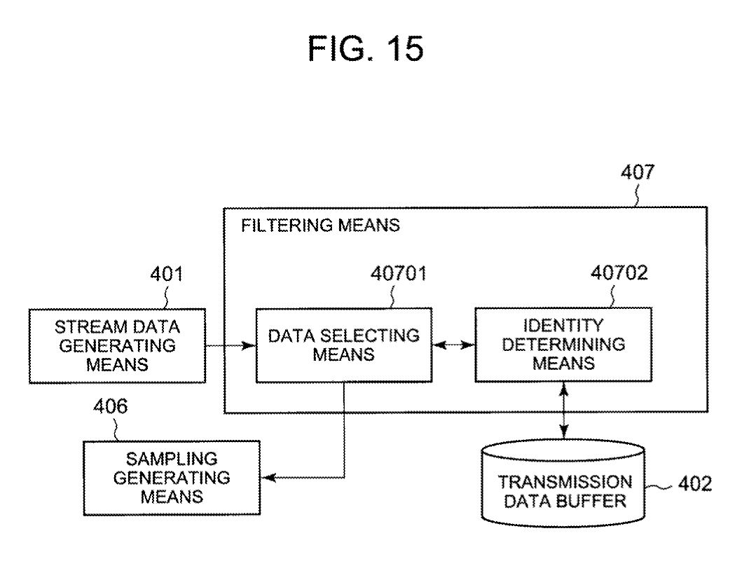

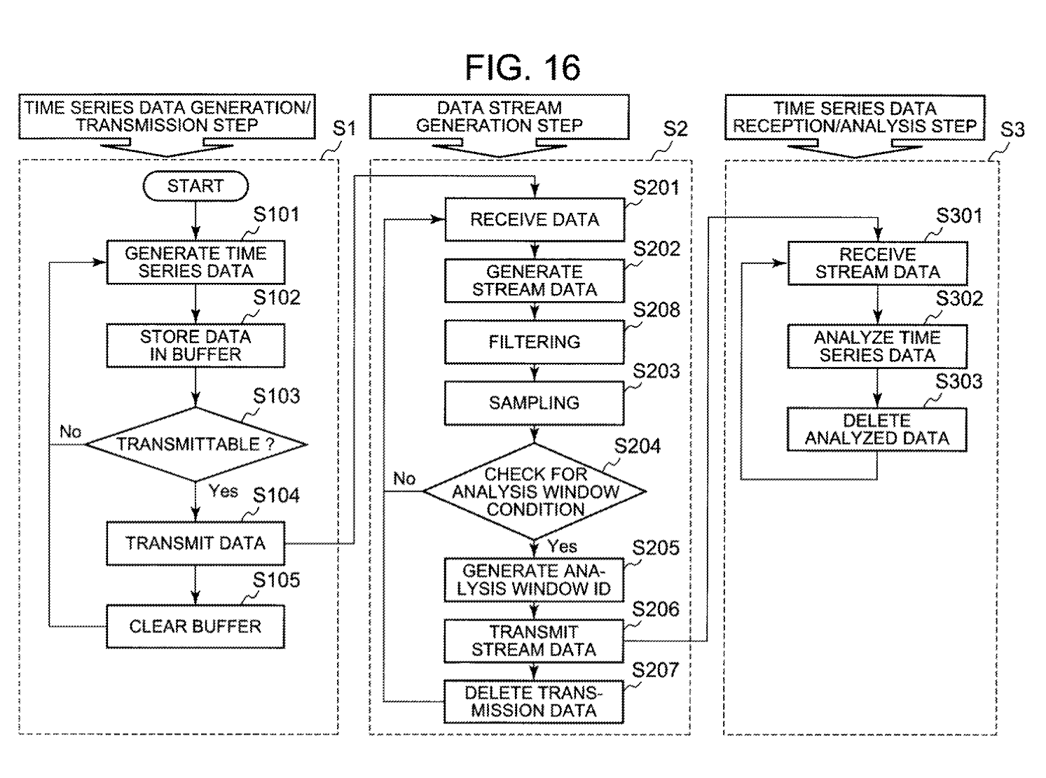

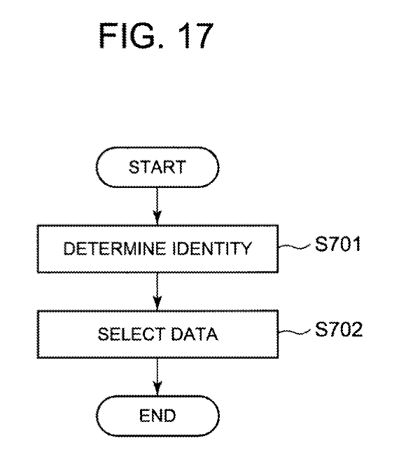

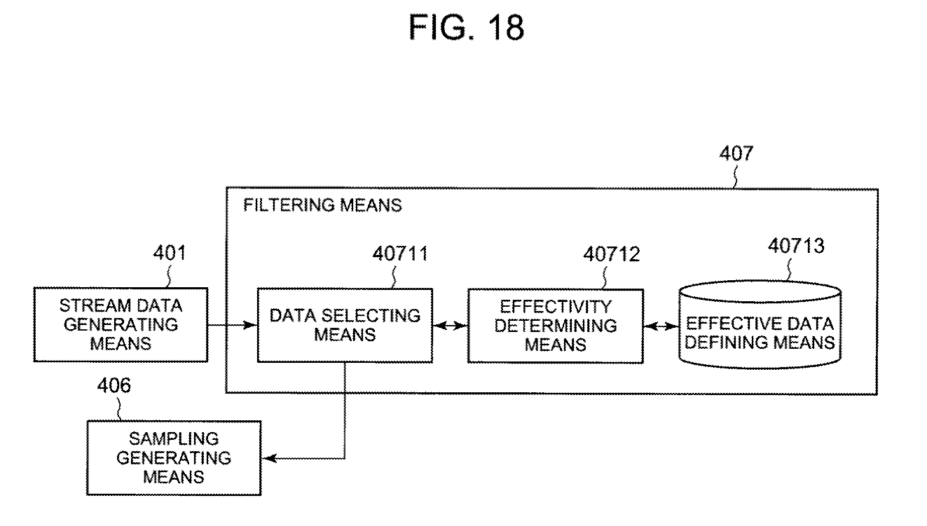

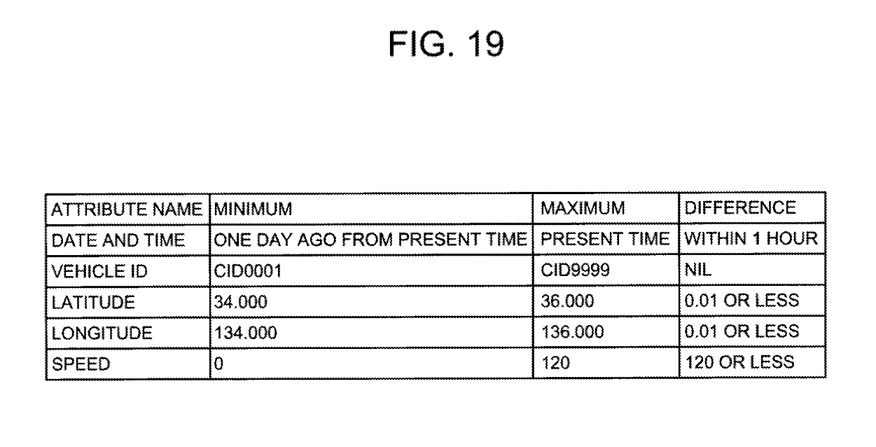

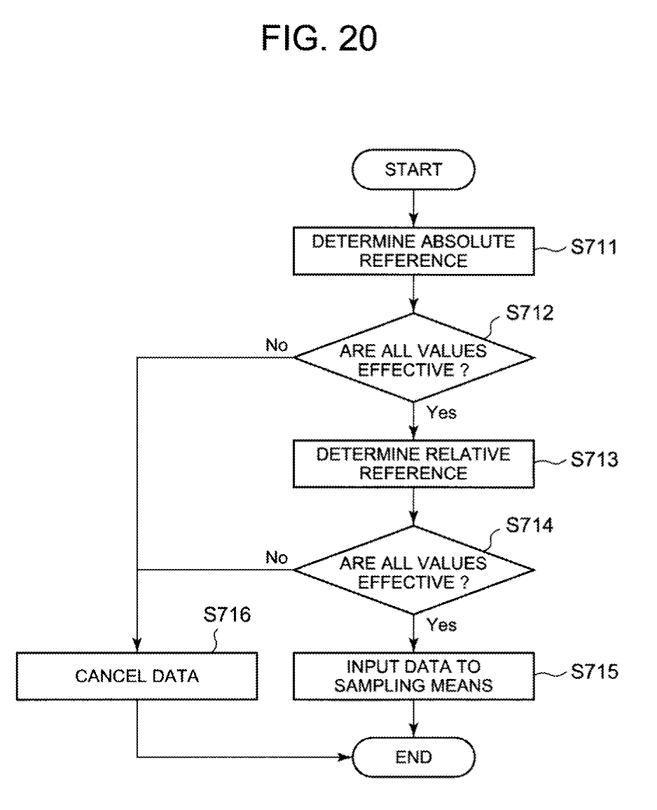

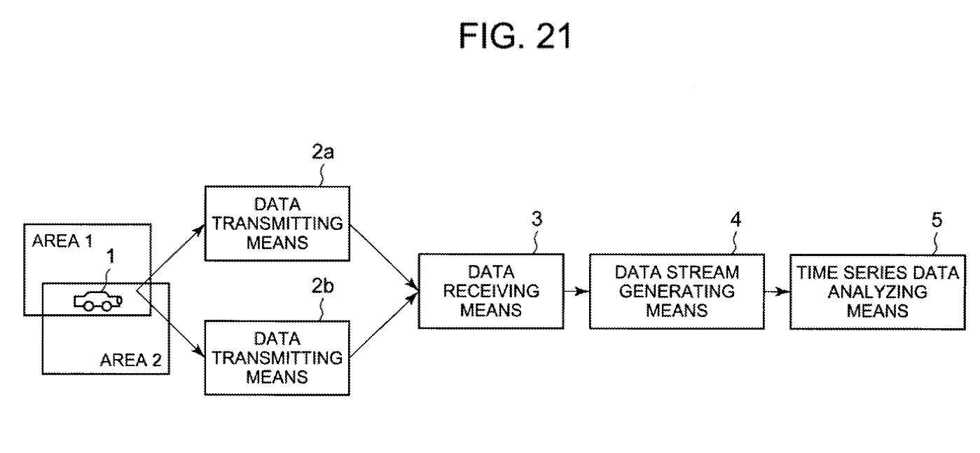

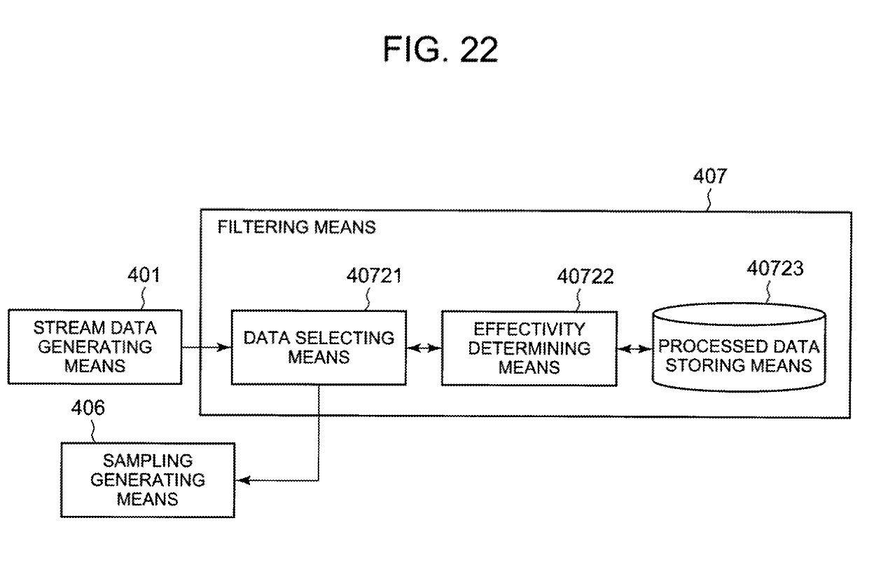

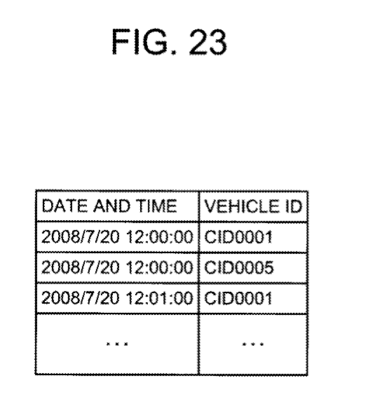

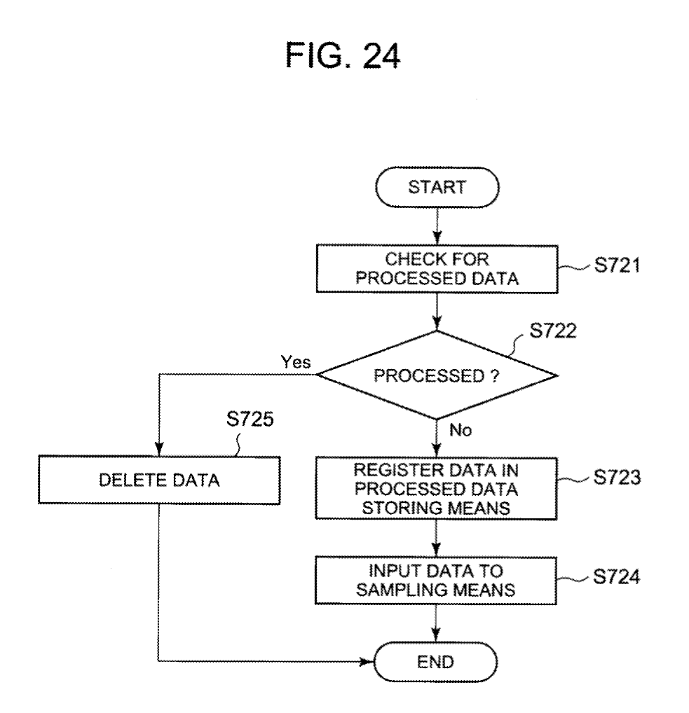

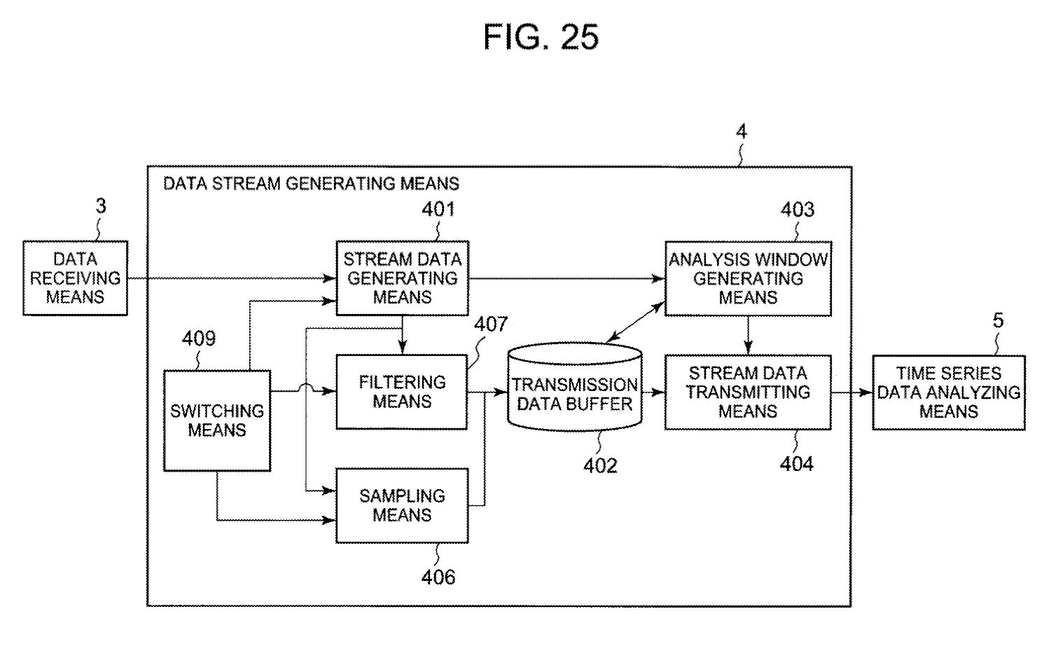

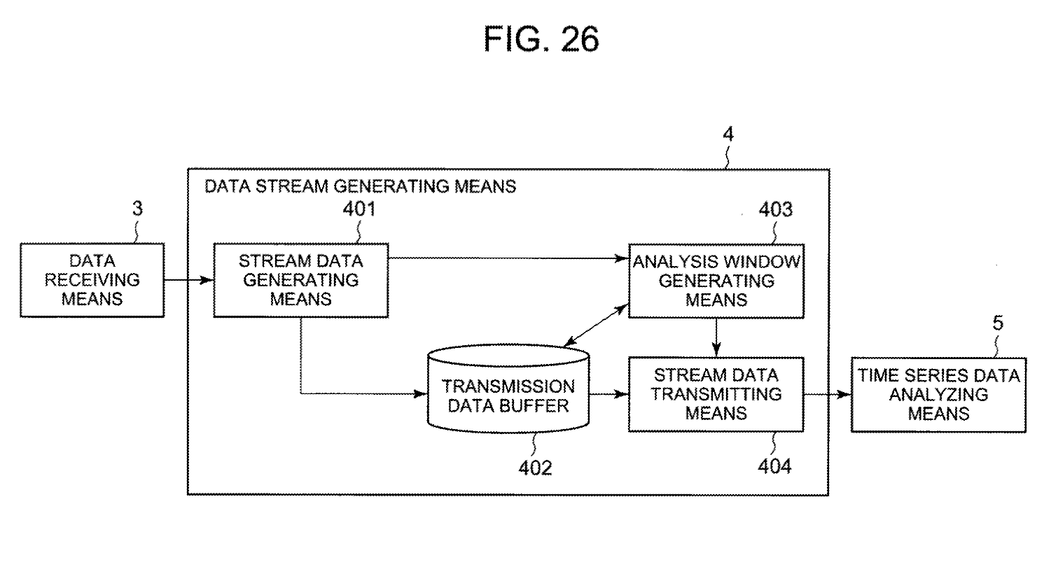

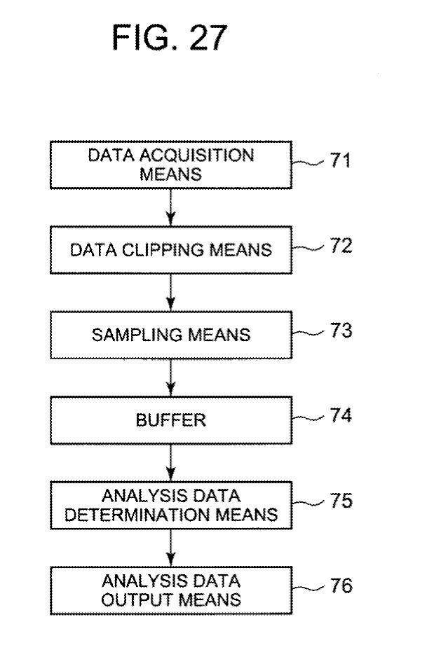

### BRIEF DESCRIPTION OF DRAWINGS

[FIG. 1] It depicts a block diagram showing an example of an analysis preprocessing system of a first exemplary embodiment of the present invention.

[FIG. 2] It depicts a block diagram illustrating a configuration example of data stream generating means.

[FIG. 3] It depicts an explanatory diagram showing one example of a physical configuration of the analysis preprocessing system.

[FIG. 4] It depicts an explanatory diagram showing an example of data generated by a time series data generation source.

[FIG. 5] It depicts an explanatory diagram illustrating an example of data transmitted by data transmitting means.

[FIG. 6] It depicts an explanatory diagram typically showing an analysis window.

[FIG. 7] It depicts an explanatory diagram showing an example of input/output of the data stream generating means.

[FIG. 8] It depicts an explanatory diagram showing an example of clipped data.

[FIG. 9] It depicts a typical diagram illustrating an example of a memory image in transmission data buffer.

[FIG. 10] It depicts a block diagram showing a configuration example of sampling means.

[FIG. 11] It depicts a flowchart showing an example of the processing progress of the first exemplary embodiment of the present invention.

[FIG. 12] It depicts a block diagram illustrating a configuration example of sampling means in a second exemplary embodiment.

[FIG. 13] It depicts a flowchart showing an example of the processing progress of a sampling rate calculation.

[FIG. 14] It depicts an explanatory diagram showing a configuration example of data stream generating means in a third exemplary embodiment.

[FIG. 15] It depicts a block diagram illustrating a configuration example of filtering means 407.

[FIG. 16] It depicts an explanatory diagram showing an example of the processing progress of the third exemplary embodiment.

[FIG. 17] It depicts a flowchart showing an example of the processing progress of filtering processing.

[FIG. 18] It depicts a block diagram showing a configuration example of filtering means in a modification of the third exemplary embodiment.

[FIG. 19] It depicts an explanatory diagram showing an example of a reference stored in effective data defining means.

[FIG. 20] It depicts a flowchart showing an example of the processing progress of filtering processing in the modification of the third exemplary embodiment.

[FIG. 21] It depicts an explanatory diagram illustrating a concrete example of a situation in which the duplication of data occurs.

[FIG. 22] It depicts a block diagram showing a configuration example of filtering means in another modification of the third exemplary embodiment.

[FIG. 23] It depicts an explanatory diagram showing an example of data identification information.

[FIG. 24] It depicts a flowchart illustrating an example of the processing progress of filtering processing in another modification of the third exemplary embodiment.

[FIG. 25] It depicts an explanatory diagram showing a configuration example of data stream generating means in a fourth exemplary embodiment.

[FIG. 26] It depicts a block diagram illustrating a configuration example of data stream generating means in a reference exemplary embodiment.

[FIG. 27] It depicts an explanatory diagram showing a minimum configuration of the present invention.

[FIG. 28] It depicts a block diagram illustrating a general configuration example of a system for collecting data to be analyzed.

### DESCRIPTION OF EMBODIMENTS

Exemplary embodiments of the present invention will hereinafter be explained with reference to the accompanying drawings.

### Exemplary Embodiment 1

FIG. 1 is a block diagram showing an example of an analysis preprocessing system of a first exemplary embodiment of the present invention. The analysis preprocessing system 7 of the present invention is equipped with data receiving means 3 which receives data generated by a time series data generation source 1, and data stream generating means 4 which processes the received data and transmits the same to time series data analyzing means 5.

The time series data generation source 1 is a data generation source which sequentially generates data with the elapse of time. Data transmitting means 2 transmits the data generated by the time series data generation source 1 to the analysis preprocessing system 7. The time series data analyzing means 5 performs analysis processing on the data input from the data stream generating means 4. As shown in FIG. 1, the time series data generation source 1 and the data transmitting means 2 may be provided in plural form.

The data receiving means 3 receives the data generated by the time series data generation sources 1 from the respective data transmitting means 2. The data stream generating means 4 samples the received data. That is, the data stream generating means 4 extracts part of the received data. The data stream generating means 4 defines a set of data targeted for one analysis from the extracted data for each analysis in the time series data analyzing means 5, and sends the same to the time series data analyzing means 5. The time series data analyzing means 5 performs an analysis using this data. The operation of the data stream generating means 4 corresponds to preprocessing of the analysis.

Incidentally, the time series data generation sources 1 and the data transmitting means 2 may be included in the analysis preprocessing system. Likewise, the time series data analyzing means 5 may be included in the analysis preprocessing system.

FIG. 2 is a block diagram showing a configuration example of the data stream generating means 4. The same reference numerals as those shown in FIG. 1 are respectively attached to the same elements as those shown in FIG. 1. The data stream generating means 4 is equipped with stream data generating means 401, sampling means 406, transmission data buffer 402, analysis window generating means 403 and stream data transmitting means 404. The stream data generating means 401 converts data received by the data receiving means 3 into a data format for analysis. The sampling means 406 performs sampling (extraction) of the data and stores the extracted data in the transmission data buffer 402. The transmission data buffer 402 is a memory that temporarily stores the data. When notified of the registration of the data in the transmission data buffer, the analysis window generating means 403 generates a set of data to be analyzed at a time by the time series data analyzing device 5. The stream data transmitting means 404 transmits data from the transmission data buffer 402 to the time series data analyzing means 5 in accordance with a command from the analysis window generating means 403.

FIG. 3 is an explanatory diagram showing one example of a physical configuration of the analysis preprocessing system. Typically, the time series data generation sources 1 exist in physically-dispersed positions, and a server collects data and performs their analyses. In the example shown in FIG. 3, n clients PC1, PC2, . . . PCn are each equipped with time series data generation sources 1 and data transmitting means 2. Each client is an information processing device such as a PC (Personal computer) or the like. Also, in the example shown in FIG. 3, a server PC8 that performs a data analysis is provided with data receiving means 3, data stream generating means 4 and time series data analyzing means 5.

The physical configuration shown in FIG. 3 is however illustrated by an example, but is not limited to the example shown in FIG. 3. For example, a plurality of time series data generation sources may be achieved by one computer. The data receiving means 3, the data stream generating means 4 and the time series data analyzing means 5 may each be achieved by different computers. By which devices the respective means should be achieved may appropriately be determined according to the number of generated data, computer's throughput, and the physical decentralized situations of the time series data generation sources 1. There may be such a configuration that the time series data generation sources 1, the data transmitting means 2, the data receiving means 3, the data stream generating means 4 and the time series data analyzing means 5 are provided in one computer.

A following description will be made of, as an example, the case where a plurality of clients generate data and transmit the data to the server PC, and the server PC performs their preprocessing and analyses.

The details of the respective means will be explained.

Each of the time series data generation sources 1 continuously generates data to be analyzed. The time series data generation source 1 is a sensor and may continuously generate sensor data to be analyzed. The time series data generation source 1 is a server device such as a Web server or the like and may continuously generate logs to be analyzed. The present exemplary embodiment will explain, as an example, the case where the time series data generation sources 1 are mounted on vehicles (probe cars) and are, for example, sensors which measure their speed, positions, heading directions and the like. Tens of thousands of probe cars are driven, data from sensors of the respective probe cars are collected and then analyzed, so that Jam information can be generated. The present invention is however applicable even to other than the data analyses of the probe cars. Although there is shown in FIG. 3 the case where each PC operates as the time series data generation source 1 and the data transmitting means 2, base stations provided separately from the probe cars correspond to the data transmitting means 2 in the present example.

FIG. 4 is an explanatory diagram showing an example of data generated by a sensor (the time series data generation source 1) provided in each individual probe car. In the present example, the time series data generation source 1 provided in each individual probe car generates data including the date and time, vehicle ID, latitude, longitude and speed. The date and time are date and time of generation of data. The vehicle ID is ID (identification information) of each probe car equipped with the time series data generation source 1. The respective probe cars are each assigned unique vehicle ID. The latitude is latitude of a position of each probe car, and the longitude is longitude of a position of each probe car. The speed is speed of each probe car and is speed per hour in the example shown in FIG. 4. Thus, the data shown in FIG. 4 is data generated at “2008/7/20/12:00”. A probe car “CID0001” indicates that it exists at “latitude 35.000” and “longitude 135.000” and is running at a speed of 60.0 km per hour. In the present example, a set of the date and time, vehicle ID, latitude, longitude and speed is defined as one datum.

Each of the data transmitting means 2 transmits data generated by the time series data generation source 1 to the analysis preprocessing system (server PC). In the present example, the base station provided separately from the probe car corresponds to the data transmitting means 2. Transmitting means (not shown) that transmits data to the base station is also provided in each probe car. The transmitting means (not shown) provided in each probe car transmits data to the base station (the data transmitting means 2) via a wireless LAN. The base station (the data transmitting means 2) transmits the data to its corresponding server PC. The base station (the data transmitting means 2) is connected to its corresponding server PC via a wired LAN, for example. The present invention is applicable even to the case in which data other than the data collected from the probe cars is targeted. A data transmission method of the data transmitting means 2 is not limited in particular. Data may be transmitted using, for example, FTP (FILE TRANSFER PROTOCOL RFC 959).

FIG. 5 is an explanatory diagram showing an example of data transmitted by the data transmitting means 2. The data transmitting means 2 may desirably transmit a fixed number of data in a lump without transmitting the individual data to the server PC individually. Transmitting the plural pieces of data in a lump in such a way enables a reduction in communication cost. The data transmitting means 2 links data by delimiters 107 and adds a header 106 thereto, then transmitting the data to the server PC as illustrated by an example in FIG. 5. The header 106 is a header defined by a communication protocol and includes, for example, parameters such as the size of transmission data. The delimiter 107 is information that indicates the boundary between individual data.

The data receiving means 3 receives the data (e.g., the data illustrated by the example in FIG. 5) transmitted by the data transmitting means 2 therein. The data receiving means 3 may receive the data in accordance with the same communication protocol as that of the data transmitting means 2. The data may be received by the FTP, for example.

The data stream generating means 4 divides the data received by the data receiving means 3 into individual data, and aggregates them into a set of data for the time series data means 5 to analyze. The data stream generating means 4 performs sampling of data and generates an analysis window from the sampled data. Normally, the time series data analyzing means 5 repeats the analysis of the set of the data without analyzing the data one by one. The analysis window is a set of data to be analyzed in one analysis. FIG. 6 is an explanatory diagram typically showing an analysis window. Respective round marks shown in FIG. 6 each indicate data generated with the elapse of time. A set of data 110 corresponds to an analysis window 120. The time series data analyzing means 5 performs one analysis processing using one analysis window. The data stream generating means 4 performs a process for determining an analysis window from the sampled data and transmits the analysis window to the time series data analyzing means 5.

As the type of the analysis window, there may be mentioned, for example, a Time-Base Window and a Topple-Base Window. The Time-Base Window is an analysis window in which pieces of data that belong to within a predetermined time are aggregated for each predetermined time. The Topple-Base Window is an analysis window in which pieces of data are specified by a predetermined number in time-series order and complied. FIG. 6 shows an example of the Topple-Base Window and shows the case in which analysis windows are generated by two data.

The data stream generating means 4 defines ID (window ID) for identifying each analysis window every analysis window, interpolates the window ID into each data and passes the same to the time series data analyzing means 5.

FIG. 7 is an explanatory diagram showing an example of the input/output of the data stream generating means 4. A plurality of data linked by delimiters 107 and including a communication header 106 are inputted from the data receiving means 3 to the data stream generating means 4. The data stream generating means 4 clips the individual data from the input data, allocates window ID to the data and passes the data assigned the window ID to the time series data analyzing means 5. The data stream generating means 4 allocates the common window ID to the respective data each included in one analysis window. Sets of the data to which the common window ID is allocated are analyzed simultaneously in one analysis. The individual data assigned the window ID is data generated by the time series data generation sources 1. In the present example, each data contains the date and time, vehicle ID, latitude, longitude and speed.

The respective elements provided in the data stream generating means 4 will be explained with reference to FIG. 2 and the like. The stream data generating means 401 performs format conversion on the data that the data receiving means 3 receives from each data transmitting means 2 (not shown in FIG. 2 and refer to FIG. 1) to divide the same into each individual data. The stream data generating means 401 may determine a header 106 and delimiters 107 (refer to FIG. 7) to clip data between the header 106 and the delimiters 107 and data between the delimiters 107. The format of the data has been standardized by RFC (Request for Comments) or the like. When the received data conforms to the specifications of RFC, a boundary between a header and data and a delimiter between data may be determined in accordance with the specifications to clip each data. FIG. 8 shows an example of data clipped by the stream data generating means 401. When the data illustrated by the example in FIG. 5 is input, the stream data generating means 401 clips three data as shown in FIG. 8.

The sampling means 406 samples the individual data clipped by the stream data generating means 401 and stores the sampled data in the transmission data buffer 402. The sampling means 406 cancels the respective unsampled data.

The transmission data buffer 402 is a memory that stores therein the data sampled by the sampling means 406. FIG. 9 is a typical diagram showing an example of a memory image in the transmission data buffer 402. FIG. 9 illustrates by an example the case where a list structure is adopted. One datum is stored in a memory area 131 that stores one datum therein. Pointers 132 that link respective memory areas are defined. Incidentally, the sampling means 406 notifies the analysis window generating means 403 of the respective pointers via the stream data generating means 402 when the respective data are stored. Alternatively, the sampling means 406 may directly notify the analysis window generating means 403 of the pointers. Tracing the pointers enables access to the respective data in sequence. The form of storing the data in the transmission data buffer 402 is however not limited to the example of FIG. 9. For example, the transmission data buffer 402 may store data therein in a table structure instead of the list structure.

The analysis window generating means 403 receives notification of each pointer to the memory area with the data stored therein at the timing at which the sampling means 406 stores the data in the transmission data buffer, and thereby generates an analysis window based on the pointer. Specifications of the analysis window have been set to the analysis window generating means 403 in advance. The specifications of the analysis window include the type of the analysis window, and the size of the window. As the type of the analysis window, a time-based window in which an analysis is conducted, or a topple-based window in which an analysis is done is determined. As the window size, time is determined in the case of the time-based window, and the number of data is determined in the case of the topple-based window.

The analysis window generating means 403 generates an analysis window in accordance with the prescribed specifications. For example, assume that the analysis is determined to be conducted by the time-based window and the time is defined as the window size. In this case, when generating the analysis window, the analysis window generating means 403 stores therein the date and time of generation of the analysis window and adds a window size to the date and time to thereby calculate the timing at which the next analysis window is generated. When the analysis window generating means 403 receives the notification of the corresponding pointer from the sampling means 406 along with the addition of new data, the analysis window generating means 403 obtains access to a field at the date and time for data in a memory area indicated by the notified pointer. The analysis window generating means 403 determines whether the date and time exceeding the timing at which the next analysis window is generated, is being stored. When the date and time that exceed the timing at which the next analysis window generated, is being stored, the analysis window generating means 403 allocates new window ID to the respective data stored in the transmission data buffer to thereby define it as one analysis window of those, and issues a command for transmission of a set (analysis window) of the data to the stream data transmitting means 404.

Assume that the analysis is determined to be conducted in the topple-based window, and the number of data is defined as the window size, for example. Each time the notification of each pointer is received with the addition of new data, the analysis window generating means 403 counts the number of times its notification is received. The number of times the notification is received means the number of data stored in the transmission data buffer 402. When receiving the notification corresponding to the number defined by the window size, the analysis window generating means 403 allocates new window ID to the respective data stored in the transmission data buffer to thereby define it as one analysis window of those, and issues a command for transmission of a set (analysis window) of the data to the stream data transmitting means 404. At this time, a count value of the number of times the notification is received is initialized to 0.

Incidentally, even in both cases of the time-based window and the topple-based window, a set of pointers to memory areas that store respective data each belonging to a newly-defined analysis window is issued as a command for transmission of a data set.

When receiving the command for the transmission of the data set (i.e., each pointer to the memory area that stores data to be transmitted) from the analysis window generating means 403, the stream data transmitting means 404 transmits the data stored in the memory area indicated by each pointer to the time series data analyzing means 5. When transmitting the data, the stream data transmitting means 404 deletes the data from the transmission data buffer 402.

The time series data analyzing means 5 analyzes the data received from the data stream generating means 4. The time series data analyzing means 5 is provided with storing means (not shown) for storing the data received from the data stream generating means 4 and stores the received data in the storing means. The time series data analyzing means 5 reads the data added to which the same window ID is assigned and performs analysis on the data. The read data is deleted from the storing means. When data of each probe car is analyzed, the time series data analyzing means 5 matches the data of each probe car with a road map, for example and generates jam information indicative of at which position a jam occurs, from the average speed of the probe car. This processing is performed at predetermined intervals (e.g., intervals of 5 minutes). In this case, the analysis may be determined to be done in the time-based window. The processing to be performed by the time series data analyzing means 5 may be determined according to the data generated by each data generation source 1 and analysis purposes, and is not limited to specific analysis processing.

FIG. 10 is a block diagram showing a configuration example of the sampling means 406. The sampling means 406 is equipped with sampling rate storing means 40603, a sampling rate setting means 40602 and sample extracting means 40601.

The sampling rate storing means 40603 is a memory that stores a sampling rate. The sampling rate is a rate for sampling data from within a data group given from the stream data generating means 401.

The sampling rate setting means 40602 stores a sampling rate input from the outside in the sampling rate storing means 40603. For example, the sampling rate setting means 40602 displays GUI (Graphic User Interface) on a display device (not shown).of the analysis preprocessing system, receives a sampling rate input by the administrator of the analysis preprocessing system and stores the sampling rate in the sampling rate storing means 40603. The sampling rate may however be input by other forms.

When, for example, 20% of given data is transmitted to the time series data analyzing means 5 and targeted for analysis, the administrator of the analysis preprocessing system may input a sampling rate “0.2”. The sampling rate setting means 40602 stores the sampling rate “0.2” in the sampling rate storing means 40603. The sampling rate “0.2” is however illustrated by an example, but may be other values.

As the sampling rate, a uniform sampling rate that does not depend on the time series data generation source 1 may be set. Alternatively, the sampling rate may be determined for each time series data generation source 1 (e.g., for each vehicle ID of probe car). When the sampling rate is input for each individual time series data generation source, the sampling rate setting means 40602 stores each of the sampling rates set for each time series data generation source in the sampling rate storing means 40603.

The sample extracting means 40601 performs sampling on a plurality of data divided by format conversion in the stream data generating means 401 at the sampling rate set to the sampling rate storing means 40603, and stores the sampled data in the transmission data buffer 402. The sample extracting means 40601 cancels unsampled data. The sample extracting means 40601 extracts data at random to reduce an effect on analysis accuracy in the time series data analyzing means 5 due to the canceling of the data. Assuming that the sampling rate is s, for example, one datum is sampled from within (1/s) data. Assuming that this 1/s is n, the sample extracting means 40601 may generate random numbers in a range from 0 to n-1 every data and store the data in which the random numbers are divided by n in the transmission data buffer 402. When the sampling rate is 0.2, 1/s=5. In this case, the sample extracting means 40601 may generate random numbers in a range from 0 to 4 every data and store the data in which the random numbers are divided by 5 in the transmission data buffer 402. Incidentally, when the sample extracting means 40601 has stored the data in the transmission data buffer 402, the sample extracting means 40601 notifies the analysis window generating means 403 of a pointer for its memory area.

In the present exemplary embodiment, the data receiving means 3, and the stream data generating means 401, the sampling means 406 (the sampling rate setting means 40602 and the sample extracting means 40601), the analysis window generating means 403 and the stream data transmitting means 404 of the data stream generating means 4 are achieved by, for example, a CPU of a computer operating in accordance with an analysis preprocessing program. In this case, the analysis preprocessing system is equipped with a program storing means (not shown) that stores an analysis preprocessing program. A CPU may read the program and operate as the data receiving means 3, and the stream data generating means 401, the sampling means 406, the analysis window generating means 403 and the stream data transmitting means 404 of the data stream generating means 4 in accordance with the program. These respective means may be achieved by discrete dedicated circuits respectively.

The time series data generation sources 1, the data transmitting means 2 and the time series data analyzing means 5 are also achieved by, for example, a CPU operating in accordance with a program.

A description will next be made of operation.

FIG. 11 is a flowchart showing an example of the processing progress of the first exemplary embodiment of the present invention. The sampling rate setting means 40602 is assumed to be inputted with a sampling rate in advance and store in the sampling rate storing means 40603.

A process is described as a time series data generation/transmission step (Step S1) in which the respective time series data generation sources 1 generate data and the data transmitting means 2 transmits the data to the analysis preprocessing system. A process is described as a data stream generation step (Step S2) in which the analysis preprocessing system (e.g., server PC) having received the data therein receives data, samples it, stores the sampled data in the transmission data buffer 402 and generates an analysis window. A process is described as a time series data reception/analysis step (Step S3) in which the time series data analyzing means 5 analyzes the data. Steps S1, S2 and S3 are processes independent of one another and are carried out in parallel. That is, Steps S1, S2 and S3 are executed asynchronously.

At the time series data generation/transmission step (Step S1), the individual time series data generation sources 1 generate data continuously with the elapse of time (Step S101). The individual time series data generation sources 1 may include the time of data generation (data generation time) in the data to be generated. The individual time series data generation sources 1 transmit the data to their corresponding data transmitting means 2, which store the data in a buffer (not shown) to transmit the data in a lump (Step S102). This buffer is a buffer for buffering the data on the data transmitting means 2 side. Each data transmitting means 2 determines whether the timing at which the data stored in the buffer is transmitted is reached (Step S103). If a predetermined number of data are stored, for example, the data transmitting means 2 may determine to transmit data. If the number of stored data does not reach a predetermined number, the data transmitting means 2 may determine not to transmit data. Alternatively, if a prescribed period has elapsed from the previous data transmission, the data transmitting means 2 may determine to transmit data. If the prescribed period does not elapse, the data transmitting means 2 may determine not to transmit data. When it is determined that the timing at which the data is transmitted is reached (Yes at Step S103), the data transmitting means 2 links the data and transmits the same to the analysis preprocessing system 7 (Step S104), in which the transmitted data is deleted from the corresponding buffer (Step S105). When it is determined that the timing at which the data is transmitted is not reached, Steps S101 and S102 are repeated.

Incidentally, when the time series data generation sources 1 and the data transmitting means 2 are achieved in the same device, the time series data generation sources 1 may execute the processes of Steps S101, S102, S103 and S105.

At the data stream generation step (Step S2), the data receiving means 3 receives the data transmitted by each data transmitting means 2 (Step S201). The data receiving means 3 is also equipped with a buffer (not shown) and temporarily stores the received data in the buffer. The data receiving means 3 inputs the data in the buffer to the data stream generating means 4 in asynchronization with the data receiving timing. Therefore, Step S2 can be carried out asynchronously with Step S1.

The stream data generating means 401 performs format conversion on the data input from the data receiving means 3 and clips the individual data from the linked data (Step S202). The stream data generating means 401 inputs the clipped individual data to the sampling means 406. The sample extracting means 40601 of the sampling means 406 refers to the sampling rate stored in the sampling rate storing means 40603 and samples given data according to the sampling rate. The sample extracting means 40601 stores the sampled data in the transmission data buffer and cancels other data (Step S203). The sample extracting means 40601 notifies the analysis window generating means 403 of a pointer to a memory area with the data stored therein.

When the pointer is notified to the analysis window generating means 403, the analysis window generating means 403 determines whether a condition for generating an analysis window is satisfied (Step S204). When analysis in a topple-based window is specified, for example, the analysis window generating means 403 determines whether the notification corresponding to the number of data defined by a window size is received. Alternatively, when analysis in a time-based window is specified, the analysis window generating means 403 determines whether a period defined by the window size elapses after the time of the previous generation of analysis window. When the condition for generating the analysis window is satisfied (Yes at Step S204), the analysis window generating means 403 adds common window ID to each data to be included in the analysis window and issues a command for transmission of the analysis window (Step S205). The stream data transmitting means 404 transmits a data group (i.e., analysis window) to which the common window ID is allocated, to the time series data analyzing means 5 according to the transmission command (Step S206). The stream data transmitting means 404 deletes the data transmitted at Step S206 from the transmission data buffer 402 (Step S207).

A process for clipping each individual data and defining it as an analysis window corresponds to the preprocessing of analysis.

At the time series data reception/analysis step (Step S3), the time series data analyzing means 5 receives the data (analysis window) transmitted by the stream data transmitting means 404 (Step S301). The time series data analyzing means 5 is equipped with an analysis buffer (not shown) and temporarily stores the data transmitted by the stream data transmitting means 404 in the analysis buffer. The time series data analyzing means 5 analyzes the data stored in the analysis buffer in asynchronization with the data receiving timing (Step S302). Therefore, Steps S2 and S3 can also be carried out asynchronously. Specifically, it is possible to perform a data analysis in asynchronization with the operation of transmitting the analysis window by the stream data transmitting means 404. The time series data analyzing means 5 deletes the data that has been completed to be analyzed at Step S302 from the buffer of the time series data analyzing means 5 (Step S303).

According to the present exemplary embodiment, when the data receiving means 3 receives the data generated by the respective time series data generation sources 1 therein, the pieces of data are stored in the memory (the transmission data buffer 402), not as databases or files. In both cases of access to a database and access to a file in SQL, the processing takes time. In the invention of the present application, however, the data can be quickly transmitted to the time series data analyzing means 5 because the pieces of data are stored in the memory.

In the present exemplary embodiment in particular, not all the data received by the data receiving means 3 is stored in the transmission data buffer 402. The sample data is stored in the transmission data buffer 402. Thus, even if the time series data generation sources 1 exist in large number and large amounts of data is received, the analysis preprocessing system is capable of preventing the data from overflowing and of transmitting the preprocessed data to the time series data analyzing means 5.

Further, the individual data transmitting means 2 and time series data generation sources 1 are not allowed to perform sampling. The sampling means 406 (the sample extracting means 40601) provided in the analysis preprocessing system performs sampling in asynchronization with the data transmitting means 2 and the time series data generation sources 1. There is therefore no need to perform such control as to allow the data transmitting means 2 or the time series data generation sources 1 to perform sampling individually.

### Exemplary Embodiment 2

An analysis preprocessing system of a second exemplary embodiment of the present invention is also equipped with data receiving means 3 and data stream generating means 4 in a manner similar to the first exemplary embodiment (refer to FIG. 1). When receiving data generated by time series data generation sources 1 from data transmitting means 2, the analysis preprocessing system performs preprocessing of the data and transmits the so-preprocessed data to time series data analyzing means 5. Even in the second exemplary embodiment as with the case of the first exemplary embodiment, the data stream generating means 4 is equipped with stream data generating means 401, sampling means 406, transmission data buffer 402, analysis window generating means 403 and stream data transmitting means 404 (refer to FIG. 2). The operation of the sampling means 406 is however different from that of the first exemplary embodiment. In the first exemplary embodiment, the sampling means 406 performs sampling at the sampling rate specified from the outside. In contrast, in the present exemplary embodiment, the sampling means 406 calculates the predicted value of the amount of data to be input thereto, and the amount of use of the transmission data buffer 402, and determines a sampling rate dynamically.

FIG. 12 is a block diagram showing a configuration example of the sampling means 406 in the second exemplary embodiment. The same reference numerals as those shown in FIG. 10 are respectively attached to elements similar to the first exemplary embodiment, and their detailed description is omitted. The sampling means 406 in the second exemplary embodiment is provided with sample extracting means 40601, sampling rate storing means 40603, sampling rate calculating means 40605, flow rate monitoring means 40606 and transmission data buffer usage measuring means 40607.

The sampling rate storing means 40603 is a memory that stores a calculated sampling rate therein. In a manner similar to the first exemplary embodiment, the sample extracting means 40601 refers to the sampling rate, samples data input from the stream data generating means 401 and stores the sampled data in the transmission data buffer 402. In the present exemplary embodiment, however, the sample extracting means 40601 further notifies the flow rate calculating means 40606 of the amount of data input from the stream data generating means 401 within a predetermined time every predetermined time.

The flow rate calculating means 40606 predicts the amount of data (number of data) to be input from the stream data generating means 401 in future from the amount of data (number of data) input from the stream data generating means 401 every predetermined time. The term “future” indicates a period between the instant when the calculation for prediction of the amount of data is carried out and the instant when a predetermined time has elapsed, for example. The value of the predetermined time may be defined in advance. The flow rate calculating means 40606 may predict the amount of data to be transmitted in future by the least squares method, for example. To cite one example, the amount of data y per predetermined time sent from the stream data generating means 401 is assumed to be expressed as y=a×t+b as a linear function of time t. The flow rate calculating means 40606 is notified of the amount of data per predetermined time from the sample extracting means 40601. This means that a set oft and y is notified. The flow rate calculating means 40606 determines the values of a and b from a plurality of sets oft and y by means of the least squares method. If a function of y=a×t+b has been defined, the flow rate calculating means 40606 may substitute therein the future time at which the amount of data is to be examined, and predict the amount of data to be sent in future. This calculation is however illustrated by an example. The flow rate calculating means 40606 may predict the amount of data in future with other prediction algorithms. The flow rate calculating means 40606 stores the result of prediction of the data amount therein and provides the same to the sampling rate calculating means 40605.

The transmission data buffer usage measuring means 40607 measures a memory amount used in the transmission data buffer 402. Assume that the transmission data buffer 402 stores data in a list structure as illustrated by an example in FIG. 9, for instance. In this case, the transmission data buffer usage measuring means 40607 traces or follows a list to thereby count the number of data stored. Then, the transmission data buffer usage measuring means 40607 multiplies the number of the data by a data size per data to thereby enable the calculation of the amount of memory used in the transmission data buffer 402. This calculation is however illustrated by an example. The transmission data buffer usage measuring means 40607 may calculate the amount of memory to be used, by a calculation method corresponding to the structure of the memory of the transmission data buffer 402.

The sampling rate calculating means 40605 calculates a sampling rate by referring to the amount of data in future predicted by the flow rate monitoring means 40606 and the used amount of memory calculated by the transmission data buffer usage measuring means 40607. The sampling rate calculating means 40605 stores the maximum amount of memory usable in the transmission data buffer 402 in advance. Then, the sampling rate calculating means 40605 reads the predicted number of data from the flow rate monitoring means 40606, reads the current amount of memory usage from the transmission data buffer usage measuring means 40607 and calculates a sampling rate using these values. The sampling rate may be calculated using an equation (1) shown below, for example.

R=(((M−N)/D)/F)×0.8 equation (1)

R indicates a sampling rate. M indicates the usable maximum amount of memory. N indicates a current used memory amount. D indicates a data size per one. F indicates the amount of data (number of data) to be sent in future, which is predicted by the flow rate monitoring means 40606. (M−N) indicates the amount of free memory in the transmission data buffer 402. Dividing (M−N) by D yields the number of data storable in the free memory. Further, this is divided by F to thereby obtain the maximum sampling rate at which it is possible to prevent the transmission data buffer 402 from being overflowed. Since the prediction of the flow rate monitoring means 40606 includes an error, (((M−N)/D)/F) is multiplied by 0.8 as a coefficient in the equation (1) to prevent the occurrence of data overflowing. The value of this coefficient is not limited to 0.8.

It can be said that the equation (I) is an equation that calculates the free space from the usage of the transmission data buffer 402 and calculates sampling data from a relationship between the number of data storable in the free space and the predicted amount of data.

The sampling rate calculating means 40605 may determine a sampling rate by another method. For example, the transmission data buffer usage measuring means 40607 holds the usage of the transmission data buffer 402 set every predetermined period as a history. Likewise, the flow rate monitoring means 40606 also predicts the amount of data in future for each predetermined period and holds the result of its prediction as a history. The sampling rate, calculating means 40605 may refer to the history of the usage of the transmission data buffer 402 and the history of the predicted amount of data, and make the sampling rate low if the usage of the transmission data buffer 402 and the predicted amount of data are on the increase and make the sampling rate high if they are in reverse, thereby changing the sampling rate.

The sample extracting means 40601, the sampling rate calculating means 40605, the flow rate monitoring means 40606 and the transmission data buffer usage measuring means 40607 are achieved by, for example, a CPU of a computer operating in accordance with an analysis preprocessing program. In this case, the CPU may operate as the sample extracting means 40601, the sampling rate calculating means 40605, the flow rate monitoring means 40606, the transmission data buffer usage measuring means 40607 and the other respective means in accordance with the analysis preprocessing program. The sample extracting means 40601, the sampling rate calculating means 40605, the flow rate monitoring means 40606 and the transmission data buffer usage measuring means 40607 may be achieved by discrete dedicated circuits respectively.

FIG. 13 is a flowchart showing an example of the processing progress of a sampling rate calculation. The sample extracting means 40601 notifies the flow rate monitoring means 40606 of the amount of data sent from the stream data generating means 401 within a predetermined time every predetermined time. The flow rate monitoring means 40606 predicts the amount of data sent from the stream data generating means 401 in future from the amount of data set every predetermined time (Step S601). The transmission data buffer usage measuring means 40607 measures the present amount of memory usage in the transmission data buffer 402 (Step S602). Then, the sampling rate calculating means 40605 performs the calculation of the equation (1) using the predicted data amount and the present amount of memory usage to thereby calculate a sampling rate (Step S603).

Since the predicted data amount in future and the current amount of memory usage change, the sampling rate calculating means 40605 dynamically calculates a sampling rate according to their changes. For example, the flow rate monitoring means 40606 may determine the predicted data amount on a regular basis, and the transmission data buffer usage measuring means 40607 may also measure the used amount of memory on a regular basis and the sampling rate calculating means 40605 may recalculate the sampling rate when the predicted data amount and the used amount of memory vary.

At a time series data generation/transmission step (Step S1), a data stream generation step (Step S2) and a time series data reception/analysis step (Step S3) are similar to those of the first exemplary embodiment. Operations similar to those shown in FIG. 11 may be performed. At this time, the sample extracting means 40601 uses the sampling rate calculated by the sampling rate calculating means 40605 upon sampling of data.

The present exemplary embodiment is also capable of obtaining an advantageous effect similar to that of the first exemplary embodiment. Further, in the present exemplary embodiment, since the sampling rate is dynamically calculated from the predicted data amount in future and the current amount of memory usage, a needless free memory in the transmission data buffer 402 can be reduced while preventing data from overflowing from the transmission data buffer 402.

### Exemplary Embodiment 3

An analysis preprocessing system of a third exemplary embodiment of the present invention is equipped with data receiving means 3 and data stream generating means 4 in a manner similar to those of the first and second exemplary embodiments (refer to FIG. 1). When receiving data generated by time series data generation sources 1 from data transmitting means 2, the analysis preprocessing system performs preprocessing on the data and transmits the so-preprocessed data to time series data analyzing means 5.

FIG. 14 is an explanatory diagram showing a configuration example of the data stream generating means 4 in the third exemplary embodiment. The data stream generating means 4 in the present exemplary embodiment is equipped with filtering means 407 in addition to stream data generating means 401, sampling means 406, transmission data buffer 402, analysis window generating means 403, and stream data transmitting means 404. The stream data generating means 401, the transmission data buffer 402, the analysis window generating means 403 and the stream data transmitting means 404 are similar to those of the first and second exemplary embodiments.

In the third exemplary embodiment, the sampling means 406 performs sampling on data input from the filtering means 407. The sampling means 406 may be similar to the sampling means (refer to FIG. 10) in the first exemplary embodiment or the sampling means (refer to FIG. 12) in the second exemplary embodiment. That is, the sampling means 406 may perform sampling of the data at a sampling rate input from the outside. Alternatively, the amount of data to be sent in future is predicted and the used amount of memory is measured, and the sampling rate is then calculated, whereby sampling may be performed thereon. In the present exemplary embodiment, however, when flow rate monitoring means 40606 of the sampling means 406 predicts the amount of data to be sent in future, the amount of data to be input from the filtering means 407 in future may be predicted.

The filtering means 407 performs filtering processing on each individual data clipped by the stream data generating means 401 from the data received by the data receiving means 3. In other words, the filtering means 407 determines for each data whether the respective data clipped by the stream data generating means 401 satisfies a predetermined condition. The filtering means 407 inputs the data having satisfied the predetermined condition to the sampling means 406 and cancels the data having unsatisfied the predetermined condition. This predetermined condition is a condition indicating that each data is useful for analysis.

As an example of the predetermined condition, for instance, the condition that “contents of any data already stored in the transmission buffer 402 differ from each other” may be used. Assume that data having the same contents as that of the data already stored in the transmission data buffer 402 is stored in the transmission data buffer 402. In this case, the stream data transmitting means 404 transmits a plurality of data having the same contents to the time series data analyzing means 5. The time series data analyzing means 5 may not require the plurality of pieces of data having the same contents upon the analysis.

Assume that for example, sensors (the time series data generation sources 1) provided in individual probe cars generate data (refer to FIG. 4) including the positions of the probe cars, their speed and vehicle ID at predetermined time intervals, and the time series data analyzing means 5 performs analyses about the data. In this case, the stopped probe cars repeatedly generate the data having the same positions of the probe cars, their speed and vehicle ID. In contrast, there is a case in which when the situations (positions and speed) of a given probe car change, the analysis processing of the time series data analyzing means 5 needs their changed contents and needs not to refer to data having unchanged contents. In such a case, the pieces of data having the same positions, speed and vehicle ID redundant data and not used for analysis. To give a concrete example, when the average speed of each vehicle is calculated during analysis, the data about the stopped vehicles are not necessary for calculation of the average speed, and such pieces of data are not required to be sent to the time series data analyzing means 5 in plural form.

The filtering means 407 stores the data that satisfies the condition that “contents of any data already stored in the transmission buffer 402 differ from each other” in the transmission data buffer 402, and cancels the data (i.e., data having the same contents as that of the data already stored in the transmission data buffer 402) that does not satisfy the condition. As a result, it is possible to prevent the redundant data from being transmitted to the time series analyzing means 5.

A description will hereinafter be made of, as an example, the case where the condition that “contents of any data already stored in the transmission buffer 402 differ from each other” is used as a predetermined condition. This condition is described as a first condition. The first condition is one example of a predetermined condition indicating that the data is useful for analysis. As will be described later, other conditions may be used.

FIG. 15 is a block diagram showing a configuration example of the filtering means 407. The filtering means 407 is equipped with data selecting means 40701 and identity determining means 40702.

The identity determining means 40702 determines whether the respective data input from the stream data generating means 401 and the respective data already stored in the transmission data buffer 402 are identical in contents therebetween. The individual data input from the stream data generating means 401 are data to be targeted for determination of filtering, which will be described as filtering determination target data below.

In the present example, assume that it is essential that the time series data generation sources 1 are identical to make the contents of the data identical. It is essential that the vehicle IDs are identical in the case of the data about the probe cars illustrated by an example in FIG. 4, for example. Data different in vehicle ID are not data having the same contents even if they are coincident in latitude, longitude and speed. When the identity of the time series data generation sources 1 is taken as an essential condition for data identity, the date and time differ between respective data generated with the elapse of time. Thus, when it is determined whether the data are identical in contents, whether the data are identical in date and time may be ignored. As in the date and time, items that may be ignored whether they are identical may exist in items contained in the data.

Items (e.g., latitude, longitude and speed illustrated in FIG. 4 by way of example) that include errors in data need not to perfectly coincide with each other. In this case, the identity determining means 40702 may calculate a difference between each value included in the data stored in the transmission data buffer 402 and each value included in the filtering determination target data, and determine whether the difference falls within a predetermined range. As to the speed, for example, a difference between the speed in the data stored in the transmission data buffer 402 and the speed in the filtering determination target data is calculated. If the difference is within a range from −5 to +5, it is determined that the speed is identical. The units of −5 and +5 shown in the present example are “km/h”. Even as to the latitude and longitude, it is determined whether the difference between values of the data falls within a predetermined range. If the difference falls within the range, they may be determined to be the same contents.

Thus, when the identity determining means 40702 determines that, between the filtering determination target data and the data stored in the transmission data buffer 402, IDs (e.g., vehicle ID) of the time series data generation sources 1 coincide with each other and the contents of other items (e.g., latitude, longitude and speed) are also the same, the identity determining means 40702 may determine that the data are of the same contents. When ID of the time series data generation sources 1 do not coincide with each other or the items determined not to be the same contents exist in any other items (e.g., any of latitude, longitude and speed), the data may be determined not to have the same contents.

The data selecting means 4071 confirms whether the contents of the filtering determination target data are determined not to be the same as those of any data in the transmission data buffer 402 for each filtering determination target data. Then, the data selecting means 40701 inputs the filtering determination target data to the sampling means 406 according to the result of confirmation or cancels the same.

When the contents of the filtering determination target data are determined not to be the same as those of any data in the transmission data buffer 402, the data to be filtered satisfies the first condition. In this case, the data selecting means 40701 inputs the filtering determination target data to the sampling means 406.

In contrast, when the contents of the filtering determination target data are determined to be the same as those of any data in the transmission data buffer 402, the filtering determination target data is assumed not to satisfy the first condition. In this case, the data selecting means 40701 cancels the filtering determination target data.

The filtering means 407 (the data selecting means 40701 and identity determining means 40702) is achieved by, for example, a CPU of a computer operating in accordance with an analysis preprocessing program. In this case, the CPU may operate as the filtering means 407 (the data selecting means 40701 and identity determining means 40702) or other respective means in accordance with the analysis preprocessing program. The data selecting means 40701 and the identity determining means 40702 may be achieved by discrete dedicated circuits respectively.

FIG. 16 is an explanatory diagram showing an example of the processing progress of the third exemplary embodiment. The same reference numerals as those in FIG. 11 are respectively attached to the processes similar to those of the first exemplary embodiment, and their description is omitted. A time series data generation/transmission step (Step S1) and a time series data reception/analysis step (Step S3) are similar to those of the first exemplary embodiment.

As to a data stream generation step (Step S2), after the process in which the stream data generating means 401 performs format conversion and thereby clips the individual data from the plural pieces of data linked to one another (Step S202), the filtering means 407 performs filtering processing on the respective data (Step S208). The sampling means 406 performs sampling on the result of filtering processing. Other respects are similar to those of the first exemplary embodiment.

FIG. 17 is a flowchart showing an example of the processing progress of the filtering processing (Step S208). When the stream data generating means 401 clips the individual data (Step S202, refer to FIG. 16), the stream data generating means 401 inputs the data to the filtering means 407. The individual data are filtering determination target data.

When the filtering determination target data is input, the identity determining means 40702 determines for each filtering determination target data whether the filtering determination target data has the same contents as those of the individual data stored in the transmission data buffer 402 (Step S701).

The data selecting means 40701 inputs the filtering determination target data that is determined not to have the same contents as those of any data in the transmission data buffer 402 to the sampling means 406 (Step S702). In contrast, the data selecting means 40701 cancels the filtering determination target data that is determined to have the same contents as those of any data in the transmission data buffer 402 (Step S702). By executing the process of Step S702, data that is subjected to processing subsequent to sampling processing is selected.

The sampling means 406 performs sampling processing (Step S203) corresponding to a sampling rate, aiming at the data input from the data selecting means 40701. The sampling rate may be a value input from the outside in a manner similar to the first exemplary embodiment or a value calculated by the sampling means 406 in a manner similar to the second exemplary embodiment.

According to the present exemplary embodiment, an effect similar to that of the first or second exemplary embodiment is obtained. Further, in the present exemplary embodiment, the filtering means 407 cancels the redundant data unused for analysis before the sampling processing. It is thus possible to prevent the transmission data buffer 402 from storing the redundant data. Correspondingly, the data to be canceled in the sampling processing can be reduced, and the data can be stored in the transmission data buffer 402 as much as possible. That is, the transmission data buffer 402 can be used effectively.

The third exemplary embodiment described above has explained the case where the condition (first condition) that “contents of any data already stored in the transmission buffer 402 differ from each other” is used as the predetermined condition used in the filtering processing. A description will be made of the case in which another condition is used, as a modification of the third exemplary embodiment. In the modification of the third exemplary embodiment, the operation of the filtering means 407 differs from that of the third exemplary embodiment but other respective means are similar to those of the third exemplary embodiment.

In the modification, the condition that “the contents of data satisfy a predetermined reference” is used as a predetermined condition used in filtering processing. This condition is described as a second condition. For example, errors might be contained in the contents included in the data. Even in the case of the data containing the errors, the data can effectively be used for analysis if the data satisfies the reference. The reference for discriminating the effective data usable in analysis in this way is determined in advance. The filtering means 407 determines whether the contents of the filtering determination target data satisfy the reference. If the contents thereof do not satisfy the reference, the data is canceled.

A description will be made of, as an example, data generated by sensors (time series data generation sources 1) provided in individual probe cars. Each data often contains a position, speed, a direction and so on. These values however contain errors. In particular, the position (e.g., latitude and longitude) is generally acquired by a GPS (Global Positioning System). A large error may be included upon calculation of the position due to the effect of buildings or the like. Since the data containing such a large error cannot be used for analysis, the filtering means 407 eliminates the data.

FIG. 18 is a block diagram showing a configuration example of the filtering means 407 in the present modification. The filtering means 407 in the present modification is equipped with effective data defining means 40713, effectivity determining means 40712 and data selecting means 40711.

The effective data defining means 40713 is a storage device that stores a reference for the contents of data usable effectively. FIG. 19 is an explanatory diagram showing an example of the reference stored by the effective data defining means 40713. The reference illustrated by an example in FIG. 19 corresponds to the data illustrated by the example in FIG. 4 and indicates a reference that the date and time, vehicle ID, latitude, longitude and speed should satisfy. The “minimum” and “maximum” shown in FIG. 4 defines a range for the values of these items. If the values of the items contained in the data are included in the range from the “minimum” to “maximum”, the values of the items are effective. In the example shown in FIG. 19, for example, the date and time are effective if included in a range from “one day ago from the present time” to “the present time”. Likewise, the vehicle ID is effective if included in a range from “CID0001” to “CID9999”. Thus, when the values of the items are combinations of a character string and numeric values, the range of their numeric values may be defined. The latitude is effective if included in a range from 34.000 to 36.000. The longitude is effective if included in a range from 134.000 to 136.000. The speed is effective if included in a range from 0 to 120. Although the “minimum” and “maximum” are defined in the present example, only either of them may be defined.

A “difference” shown in FIG. 19 is a reference that prescribes or defines a relation with immediately preceding data (immediately preceding data identical in time series data generation source). In the example shown in FIG. 19, for example, the date and time are effective if a difference in date and time with respect to immediately preceding data identical in vehicle ID is within one hour. As to the vehicle ID, the “difference” is not defined. The latitude is effective if a difference in latitude with respect to the immediately preceding data identical in vehicle ID is 0.01 or less. The longitude is effective if a difference in longitude with respect to the immediately preceding data identical in vehicle ID is 0.01 or less. The speed is effective if a difference in speed with respect to the immediately preceding data identical in vehicle ID is 120 or less.

The reference that each of the “minimum” and “maximum” defines is an absolute reference that each item included in the data should satisfy. The “difference” is a relative reference that each item included in the data should satisfy in a relationship with other data. Although the absolute reference (minimum, maximum) and the relative reference (difference) are defined in the example shown in FIG. 19, only either of them may be defined.

When filtering determination target data is input from the stream data generating means 401, the effectivity determining means 40712 determines whether each item in the filtering determination target data satisfies each reference stored in the effective data defining means 40713. For example, assume that the reference illustrated by the example in FIG. 19 is being stored. The effectivity determining means 40712 determines whether the date and time, vehicle ID, latitude, longitude and speed in the filtering determination target data each are included in the range from the minimum value to the maximum value. The effectivity determining means 40712 calculates a difference between each of the date and time, latitude, longitude and speed, and a value in immediately preceding filtering determination target data, and determines whether the calculation result satisfies the reference prescribed as the “difference”.

If the effectivity determining means 40712 has determined effectivity about given filtering determination target data to determine the relative reference, the effectivity determining means 40712 stores the filtering determination target data therein until the next filtering determination target data generated at the same time series data generation source is input. Alternatively, the effectivity determining means 40712 may determine the relative reference by referring to the immediately preceding data stored in the transmission data buffer 402.

The data selecting means 40711 confirms the result of determination by the effectivity determining means 40712 for each filtering determination target data. The data selecting means 40711 inputs the filtering determination target data to the sampling means 406 according to the confirmation result or cancels the same.

When it is determined that each item in the filtering determination target data has satisfied the reference defined in the effective data defining means 40713, the filtering target data is determined to satisfy the second condition described above. In this case, the data selecting means 40711 inputs the filtering determination target data to the sampling means 406.

In contrast, when each item in the filtering determination target data is determined not to satisfy the reference defined in the effective data defining means 40713, the filtering target data is determined not to satisfy the second condition described above. In this case, the data selecting means 40711 cancels the filtering determination target data. If any item is determined not to satisfy the absolute reference or the relative reference, for example, the data selecting means 40711 cancels the filtering determination target data.

The data selecting means 40711 and the effectivity determining means 40712 of the filtering means 407 in the present modification are achieved by, for example, a CPU of a computer operating in accordance with an analysis preprocessing program. In this case, the CPU may operate as the data selecting means 40711 and the effectivity determining means 40712, and other respective means in accordance with the analysis preprocessing program. The data selecting means 40711 and the identity determining means 40712 may be achieved by discrete dedicated circuits respectively.

The processing progress of the present modification is similar to that of the third exemplary embodiment (refer to FIG. 16). Processing in the filtering processing (Step S208) however differs. FIG. 20 is a flowchart showing an example of the processing progress of the filtering processing in the present modification. When filtering determination target data is input from the stream data generating means 401, the effectivity determining means 40712 determines whether each item in the filtering determination target data satisfies the absolute reference (Step S711). When the reference illustrated by the example in FIG. 19 is defined, for example, it is determined whether the date and time, vehicle ID, latitude, longitude and speed are included in the range from the minimum value to the maximum value. When it is determined that all items satisfy the absolute reference (Yes at Step S712), the effectivity determining means 40712 determines whether each item in the filtering determination target data satisfies the relative reference (Step S713). The effectivity determining means 40712 calculates a difference between each of the time, latitude, longitude and speed, for example, and immediately preceding filtering determination target data identical in vehicle ID, and determines whether the difference satisfies the prescribed reference (“difference” illustrated by the example in FIG. 19).

The data selecting means 40711 confirms the result of determination regarding the absolute reference and the result of determination as to the relative reference. When it is determined that any item has not satisfied the reference in the determination as to the absolute reference (Step S711) or the determination as to the relative reference (Step S713) (No at Step S712 or No at Step S714), the data selecting means 40711 cancels its filtering determination target data (Step S716). When it is determined that each item has satisfied the reference at the determination as to the absolute reference (Step S711) and the determination as to the relative reference (Step S713) (Yes at Step S714), the data selecting means 40711 inputs filtering determination target data to the sampling means 406 (Step S715). As a result, data to be subjected to processing subsequent to the sampling processing is selected.

Operations subsequent to the sampling processing (Step S203, refer to FIG. 16) are similar to those of the third exemplary embodiment.

A modification in the case where the condition that “there is no duplication of any data already input from the stream data generating means 401” is used in filtering processing, will next be shown as another modification of the third exemplary embodiment. This condition is described as a third condition.

In the process from the generation of data by each time series data generation source 1 to the reception of the data by the data receiving means 3, the duplication of each time series data generation source 1 might occur and the data receiving means 3 might receive a plurality of pieces of same data. For example, when a plurality of data transmitting means 2 receive the same data from the same time series data generation source 1 and transmit the data to the analysis preprocessing system, such a matter occurs. FIG. 21 is an explanatory diagram showing a concrete example of this situation. Assume that a time series data generation source 1 is a sensor provided in a probe car, and data transmitting means 2a and 2b are base stations each of which relays data between the time series data generation source 1 and its corresponding data receiving means 3. The base station is provided for each area, and disposed such that the corresponding areas partially overlap with each other. When the probe car exists in a portion where the areas corresponding to the base stations overlap with each other, and data is sent by wireless from its position, the base stations 2a and 2b corresponding to the respective areas each receive the same data therein. Since the base stations 2a and 2b both transmit the received data to the analysis preprocessing system, the data receiving means 3 receives the plurality of pieces of same data. The so-duplicated data are unnecessary for the analysis in the time series data analyzing means 5, and the filtering means 407 eliminates the data.

FIG. 22 is a block diagram showing a configuration example of the filtering means 407 where the third condition is used. The filtering means 407 in the modification is equipped with processed data storing means 40723, effectivity determining means 40722 and data selecting means 40721.

The processed data storing means 40723 is a storage device that stores data identification information for identifying the respective data input from the stream data generating means 401. FIG. 23 shows an example of the data identification information stored in the processed data storing means 40723. When two or more pieces of data identical in the generation source of data and the generation time thereof exist, data subsequent to the second data is duplicate. Thus, as shown in FIG. 23, a combination of the date and time and ID (e.g., vehicle ID) of each time series data generation source may be taken as the data identification information. A first record in FIG. 23 means that data generated on the date and time “2008/7/20 12:00:00” at a probe car “CID0001” has already been received.

When filtering determination target data is input from the stream data generating means 401, the effectivity determining means 40722 determines by referring to the data identification information stored in the processed data storing means 40723 whether the filtering determination target data is data not yet input. If the filtering determination target data is determined to be data not yet input, the effectivity determining means 40722 stores data identification information (e.g., set of date and time and vehicle ID) of the filtering determination target data in the processed data storing means 40723.

The data selecting means 40721 confirms the result of determination by the effectivity determining means 40722 for each filtering determination target data. Then, the data selecting means 40721 inputs the filtering determination target data to the sampling means 406 according to the confirmation result or cancels the same.

The determination of the filtering determination target data to be the not-yet input data means that the filtering determination target data has been input for the first time, thus resulting in satisfaction of the third condition. In this case, the data selecting means 40721 inputs the filtering determination target data to the sampling means 406.

In contrast, the third condition is not satisfied where it is determined that the filtering determination target data is the already-input data. In this case, the data selecting means 40721 cancels the filtering determination target data.

The data selecting means 40721 and the effectivity determining means 40722 of the filtering means 407 in the present modification are achieved by, for example, a CPU of a computer operating in accordance with an analysis preprocessing program. In this case, the CPU may operate as the data selecting means 40721 and the effectivity determining means 40722 or other respective means in accordance with the analysis preprocessing program. The data selecting means 40721 and the effectivity determining means 40722 may be achieved by discrete dedicated circuits respectively.

The processing progress of the present modification is similar to that of the third exemplary embodiment (refer to FIG. 16). The processing at the filtering processing (Step S208) however differs. FIG. 24 is a flowchart showing an example of the processing progress of the filtering processing in the present modification.

When filtering determination target data is input from the stream data generating means 401, the effectivity determining means 40722 determines whether the filtering determination target data is not-yet input data (Step S721). Described specifically, the effectivity determining means 40722 determines whether data identification information (e.g., set of the date and time, and vehicle ID) of the input filtering determination target data has already been stored in the processed data storing means 40723. If the data identification information has not been stored therein (No at Step S722), the filtering determination target data corresponds to the not-yet input data (firstly input data). In contrast, if the data identification information has been stored therein (Yes at Step S722), the filtering determination target data is already input.

If the filtering determination target data is the firstly input data (No at Step S722), the effectivity determining means 40722 additionally stores the data identification information of the filtering determination target data in the processed data storing means 40723 (Step S723).

The data selecting means 40721 confirms the result of determination by the effectivity determining means 40722. If the input filtering determination target data has already been input (Yes at Step S722), the data selecting means 40721 cancels the filtering determination target data (Step S725). If the input filtering determination target data is the firstly input data (No at Step S722), the data selecting means 40721 inputs the filtering determination target data to the sampling means 406 (Step S724). As a result, data to be subjected to processing subsequent to the sampling processing is selected.

The operations subsequent to the sampling processing (Step S203, refer to FIG. 16) are similar to those of the third exemplary embodiment.

The filtering means 407 may take such a configuration as to combine plural conditions among the aforementioned first to third conditions, input only data that satisfies the plural conditions to the sampling means 406, and cancel other data. For example, the filtering means 407 may take such a configuration as to input only data that satisfies the first and second conditions to the sampling means 406, and cancel other data. How to combine the conditions is not limited in particular.

The respective modifications shown in FIGS. 18 and 22 are also capable of obtaining effects similar to that of the third exemplary embodiment.

### Exemplary Embodiment 4

An analysis preprocessing system of a fourth exemplary embodiment of the present invention is equipped with data receiving means 3 and data stream generating means 4 in a manner similar to the first, second and third exemplary embodiments (refer to FIG. 1). When receiving data generated by time series data generation sources 1 from data transmitting means 2, the analysis preprocessing system performs preprocessing on the data and sends the same to time series data analyzing means 5.

FIG. 25 is an explanatory diagram showing a configuration example of the data stream generating means 4 in the fourth exemplary embodiment. The data stream generating means 4 in the present exemplary embodiment is equipped with switching means 409 in addition to stream data generating means 401, sampling means 406, filtering means 407, transmission data buffer 402, analysis window generating means 403, and stream data transmitting means 404. The analysis preprocessing system of the fourth exemplary embodiment performs either filtering processing or sampling processing according to the changeover by the switching means 409.

The transmission data buffer 402, the analysis window generating means 403 and the stream data transmitting means 404 are similar to those of each of the first to third exemplary embodiments.

The switching means 409 controls the stream data generating means 401, the filtering means 407 and the sampling means 406 to operate the same so as to perform either of the filtering processing or the sampling processing.

When the sampling processing is carried out, the switching means 409 causes the stream data generating means 401 to input clipped individual data to the sampling means 406, and allows the sampling means 406 to sample the data. At this time, the switching means 409 allows the filtering means 407 not to operate.

When the filtering processing is executed, the switching means 409 causes the stream data generating means 401 to input clipped individual data to the filtering means 407, and allows the filtering means 407 to filter the data. At this time, the switching means 409 allows the sampling means 407 not to operate.

The switching means 409 performs switching as to whether, for example, the sampling processing should be done or the filtering processing should be done, according to a changeover instruction input from the outside. The changeover instruction may be input via an input device (not shown) such as a keyboard or the like. Alternatively, the changeover instruction may be input via a communication network.

The stream data generating means 401 performs format-conversion of data received by the data receiving means 3 in a manner similar to the first exemplary embodiment to clip each individual data (refer to FIG. 8, for example). Then, when the switching means 409 indicates the sampling processing, the stream data generating means 401 inputs the data to the sampling means 406. When the switching means 409 indicates the filtering processing, the stream data generating means 401 inputs the data to the filtering means 407.

When the switching means 409 indicates the sampling processing; the sampling means 406 performs sampling on the data input from the stream data generating means 401. The configuration of the sampling means 406 may be similar to that of the first exemplary embodiment (refer to FIG. 10) or similar to that of the second exemplary embodiment (refer to FIG. 12). That is, the sampling means 406 may perform sampling of data at a sampling rate input from the outside in a manner similar to the first exemplary embodiment. Alternatively, as with the case of the second exemplary embodiment, the sampling means 406 itself may calculate a sampling rate and perform sampling. When the switching means 409 indicates the filtering processing, the sampling means 406 is controlled by the switching means 409 so as not to operate.

When the switching means 409 indicates the filtering processing, the filtering means 407 performs filtering on the data input from the stream data generating means 401. The filtering means 407 may have a configuration similar to that of the third exemplary embodiment or a configuration similar to that of each modification of the third exemplary embodiment. That is, the filtering means 407 may be of a configuration similar to the that shown in FIG. 15 and perform filtering using the condition that “contents of any data already stored in the transmission buffer 402 differ from each other”. Alternatively, the filtering means 407 may be of a configuration similar to that shown in FIG. 18 and perform filtering using the condition that “the contents of data satisfy a predetermined reference”. Or the filtering means 407 may be of a configuration similar to that shown in FIG. 22 and perform filtering using the condition that “there is no duplication of any data already input from the stream data generating means 401”. Even in any case, the filtering means 407 stores data that satisfies the condition in the transmission data buffer 402.

The switching means 409 is achieved by, for example, a CPU of a computer operating in accordance with an analysis preprocessing program. In this case, the CPU may operate as the switching means 409 and other respective means in accordance with the analysis preprocessing program. In addition, the switching means 409 may be achieved as a dedicated circuit.

With such a configuration as described above, the analysis preprocessing system operates in the same manner as that of the first or second exemplary embodiment when the switching means 409 indicates the sampling operation (refer to FIG. 11).

In contrast, when the switching means 409 indicates the filtering operation, the filtering means 407 performs filtering instead of Step S203 shown in FIG. 11. In this case, the stream data generating means 401 inputs each data to the filtering means 407. The data selecting means 40701 (or data selecting means 40711 and 40721) of the filtering means 407 stores data that satisfies the condition in the transmission data buffer 402. Then, the data selecting means 40701 cancels data that does not satisfy the condition.

Even in the fourth embodiment, the sampling processing or the filtering processing is performed on each data clipped by the stream data generating means 401, thereby making it possible to prevent the data in the transmission data buffer from overflowing. A method for reducing the number of data is switched according to the analysis and the contents of data in such a manner that when a reduction in the number of data by sampling is preferred, the sampling is carried out, and when a reduction in the number of data by filtering is preferred, the filtering is executed.

Each of the aforementioned exemplary embodiments has illustrated the case where the preprocessing is carried out in which the time series data generation sources 1 provided in the probe cars generates data and sampling or the like is performed on the data to thereby generate the analysis windows. Such analysis windows can be used even in the analysis in which warning is performed using, for example, an incident map, in addition to the generation of jam information. Likewise, the analysis windows can be used even in the analysis in which each person is caused to hold a sensor used as the time series data generation source 1 and warning is given to the person using an incident map. The type of data is not limited to the data used for such analyses as described above. The present invention is applicable to preprocessing relative to various data to be analyzed.

There is also considered an exemplary embodiment in which no sampling is done. This exemplary embodiment will be explained below. An analysis preprocessing system of the present exemplary embodiment is equipped with data receiving means 3 and data stream generating means 4 in a manner similar to the first exemplary embodiment shown in FIG. 1. FIG. 26 is a block diagram showing a configuration example of the data stream generating means 4 in the exemplary embodiment in which no sampling is done. In this exemplary embodiment, the data stream generating means 4 is equipped with stream data generating means 401, transmission data buffer 402, analysis window generating means 403 and stream data transmitting means 404. These respective means are similar to those of the first exemplary embodiment. However, sampling means 406 is not provided therein. The stream data generating means 401 stores all of clipped data in the transmission data buffer 402. When the data are stored in the transmission data buffer 402, the stream data generating means 401 notifies the analysis window generating means 403 of, for example, a pointer to each memory area in which the data is stored, as notification about its storage.

In the case of this configuration, Step S203 (sampling processing) is not performed at the data stream generation step (Step S2, refer to FIG. 11), but other respects are similar to those of the first exemplary embodiment.

Even as the configuration shown in FIG. 26, data can be rapidly transmitted to time series data analyzing means 5 in comparison with the case where the data is stored as a database or file. However, to prevent the data in the transmission data buffer 402 from overflowing, the sampling means 406 is desirably provided as shown in each of the first through fourth exemplary embodiments.

A minimum configuration of the present invention will next be described. FIG. 27 is an explanatory diagram showing the minimum configuration of the present invention. An analysis preprocessing system of the present invention is equipped with data acquisition means 71, data clipping means 72, a buffer 74, sampling means 73, analysis data determination means 75 and analysis data output means 76.

The data acquisition means 71 (e.g., the data receiving means 3) acquires a data group generated by a plurality of data generation sources.

The data clipping means 72 (e.g., the stream data generating means 401) clips each data from the data group acquired by the data acquisition means 71.

The buffer 74 (e.g., the transmission data buffer 402) stores data used for analysis.

The sampling means 73 (e.g., sampling means 406) samples part of the clipped data and stores the sampled data in the buffer 74.

The analysis data determination means 75 (e.g., analysis window generating means 403) determines an analysis data group (e.g., analysis window) which is a set of data used for analysis, from the data stored in the buffer 74.

The analysis data output means 76 (e.g., the stream data transmitting means 404) transmits the analysis data group to data analyzing means (e.g., the time series data analyzing means 5) for analyzing the data.

With such a configuration as described above, even if large amounts of data are transmitted from a large number of data generation sources, it is possible to rapidly pass data to means for analyzing the data while preventing the overflowing of the data.

The above-described exemplary embodiment has disclosed the configuration in which the sampling means 73 samples data at random. According to such a configuration, influence on the analysis accuracy of data can be reduced.

Also, the above exemplary embodiment has disclosed a configuration in which the sampling means 73 includes: prediction means (e.g., the flow rate monitoring means 40606) which predicts an amount of data to be given in future from actual results of an amount of data given every predetermined time; buffer usage measuring means (e.g., the transmission data buffer usage measuring means 40607) which measures the usage of the buffer 74; sampling rate calculating means (e.g., the sampling rate calculating means 40605) which calculates a sampling rate, based on the predicted amount of data and the usage of the buffer; and sample extracting means (e.g., the sample extracting means 40601) which samples data according to the sampling rate.

According to such a configuration, the sampling rate can dynamically be determined according to the usage of the buffer 74 and the predicted amount of data.

The above-described exemplary embodiment has disclosed a configuration in which the sampling rate calculating means calculates free space of the buffer 74 from the usage of the buffer 74, and calculates sampling data from the relationship between the number of data storable in the free space and the predicted amount of data.

According to such a configuration, needless free space in the buffer 74 can be reduced.

Also, the above exemplary embodiment has disclosed a configuration in which the sampling means includes: sampling rate storing means (e.g., the sampling rate storing means 40603) that stores a sampling rate input from the outside; and sample extracting means (e.g., the sample extracting means 40601) that samples data according to the sampling rate.

Further, the above exemplary embodiment has disclosed a configuration in which filtering means (e.g., the filtering means 407) is provided which determines, for each data clipped by the data clipping means 72, whether each data satisfies a predetermined condition, inputs data that satisfies the predetermined condition to the sampling means 73 and cancels data that does not satisfy the predetermined condition.

According to such a configuration, it is possible to prevent redundant data from being stored in the buffer 74. Correspondingly, data to be canceled in sampling processing can be reduced, and data can be stored in the buffer 74 as much as possible.

Also, the above exemplary embodiment has disclosed a configuration in which the filtering means includes: contents coincidence/non-coincidence determining means (e.g., the identity determining means 40702) which determines, for each data clipped by the data clipping means 72, whether each data satisfies a condition in which contents of any data already stored in the buffer 72 differ from each other; and data selecting means (e.g., the data selecting means 40701) which cancels data that does not satisfy the condition and inputs data that satisfies the condition to the sampling means.

Further, the above exemplary embodiment has disclosed a configuration in which the filtering means includes: reference storing means (e.g., the effective data defining means 40713) which stores a reference indicating that the contents contained in data are effective; reference determining means (e.g., the effectivity determining means 40712) which determines, for each data clipped by the data clipping means 72, whether the contents of each data satisfy the reference; and data selecting means (e.g., the data selecting means 40711) which cancels data whose contents do not satisfy the reference and inputs data whose contents satisfy the reference to the sampling means 73.

Furthermore, the above exemplary embodiment has disclosed a configuration in which the filtering means includes: data identification information storing means (e.g., the processed data storing means 40723) which stores data identification information of each data input from the data clipping means 72; duplication determining means (e.g., effectivity determining means 40722) which determines, upon receiving each data input from the data clipping means 72, whether data identification information of the data is being stored in the data identification information storing means and, when the data identification information is not stored therein, stores the data identification information of the data in the data identification information storing means; and data selecting means (e.g., the data selecting means 40721) which cancels data whose data identification information has been determined to be stored in the data identification information storing means, and inputs data whose data identification information has been determined not to be stored in the data identification information storing means, to its corresponding sampling means.

Further, the above exemplary embodiment has disclosed a configuration that includes: filtering means (e.g., the filtering means 407) which determines, for each data clipped by the data clipping means, whether each data satisfies a predetermined condition, stores data that satisfies the predetermined condition in the buffer 74 and cancels data that does not satisfy the predetermined condition; and switching means (e.g., the switching means 409) which controls to which of the sampling means 73 and the filtering means each data clipped by the data clipping means 72 is input.

Furthermore, the above embodiment has disclosed a configuration in which the analysis data determination means 75 determines, for every predetermined period, a set of data stored in the buffer 74 within the predetermined period as an analysis data group.

Also, the above exemplary embodiment has disclosed a configuration in which the analysis data determination means 75 determines a set of a predetermined number of data as an analysis data group each time the number of data stored in the buffer 74 reaches the predetermined number.

Further, the above exemplary embodiment has disclosed a configuration in which the analysis data output means 76 deletes each data that belongs to the analysis data group transmitted to the data analyzing means, from the buffer 74.

Still further, the above exemplary embodiment has disclosed a configuration that includes data analyzing means for analyzing data, the data analyzing means performing an analysis asynchronously with the analysis data output means 76 by holding the analysis data group output by the analysis data output means 76 and deleting an analysis data group after the completion of analysis.

Incidentally, the characteristic configurations of such an analysis preprocessing system as shown in each of the following (1) through (15) are shown in the above exemplary embodiments.

(1) An analysis preprocessing system includes: a data acquisition unit which acquires a data group generated by a plurality of data generation sources; a data clipping unit which clips each data from the data group acquired by the data acquisition unit; a buffer which stores data used for analysis; a sampling unit which samples part of the clipped data mid stores the sampled data in the buffer; an analysis data determination unit which determines an analysis data group that is a set of the data used for analysis, from the data stored in the buffer; and an analysis data output unit which transmits the analysis data group to a data analyzing unit for analyzing data.

(2) In the analysis preprocessing system, the sampling unit samples data at random.

(3) In the analysis preprocessing system, the sampling unit includes: a prediction unit which predicts an amount of data to be given in future from actual results of an amount of data given every predetermined time; a buffer usage measuring unit which measures usage of the buffer; a sampling rate calculating unit which calculates a sampling rate, based on the predicted amount of data and the usage of the buffer; and a sample extracting unit which samples data according to the sampling rate.

(4) In the analysis preprocessing system, the sampling rate calculating unit calculates free space of the buffer from the usage of the buffer and calculates sampling data from a relationship between the number of data storable in the free space and the predicted amount of data.

(5) In the analysis preprocessing system, the sampling unit includes: a sampling rate storing unit which stores a sampling rate input from the outside; and a sample extracting unit which samples data according to the sampling rate.

(6) The analysis preprocessing system includes a filtering unit which determines, for each data clipped by the data clipping unit, whether each data satisfies a predetermined condition, inputs data that satisfies the predetermined condition to the sampling unit, and cancels data that does not satisfy the predetermined condition.

(7) In the analysis preprocessing system, the filtering unit includes a contents coincidence/non-coincidence determining unit which determines, for each data clipped by the data clipping unit, whether each data satisfies a condition in which contents of any data already stored in the buffer differ from each other, and a data selecting unit which cancels each data that does not satisfy the condition and inputs each data that satisfies the condition to the sampling unit.

(8) In the analysis preprocessing system, the filtering unit includes: a reference storing unit which stores a reference indicating that the contents contained in data are effective; a reference determining unit which determines, for each data clipped by the data clipping unit, whether the contents of each data satisfy the reference; and a data selecting unit which cancels each data whose contents do not satisfy the reference and inputs each data whose contents satisfy the reference to the sampling unit.

(9) In the analysis preprocessing system, the filtering unit includes: a data identification information storing unit which stores data identification information of each data input from the data clipping unit; a duplication determining unit which determines, upon receiving each data input from the data clipping unit, whether data identification information of the data is being stored in the data identification information storing unit and, when the data identification information is not stored therein, stores the data identification information of the data in the data identification information storing unit; and a data selecting unit which cancels data whose data identification information has been determined to be stored in the data identification information storing unit and inputs data whose data identification information has been determined not to be stored in the data identification information storing unit, to the sampling unit.

(10) The analysis preprocessing system further includes: a filtering unit which determines, for each data clipped by the data clipping unit, whether each data satisfies a predetermined condition, stores each data that satisfies the predetermined condition in the buffer and cancels each data that does not satisfy the predetermined condition; and a switching unit which controls to which of the sampling unit and the filtering unit each data clipped by the data clipping unit is input.

(11) In the analysis preprocessing system, the analysis data determination unit determines, for every predetermined period, a set of data stored in the buffer within the predetermined period as an analysis data group.

(12) In the analysis preprocessing system, the analysis data determination unit determines a set of a predetermined number of data as an analysis data group each time the number of data stored in the buffer reaches the predetermined number.

(13) In the analysis preprocessing system, the analysis data output unit deletes each data that belongs to the analysis data group transmitted to the data analyzing unit, from the buffer.

(14) The analysis preprocessing system further includes a data analyzing unit for analyzing data, the data analyzing unit performing an analysis asynchronously with the analysis data output unit by holding the analysis data group output by the analysis data output unit and deleting an analysis data group after the completion of analysis.

(15) An analysis preprocessing system includes: data acquisition means which acquires a data group generated by a plurality of data generation sources; data clipping means which clips each data from the data group acquired by the data acquisition means; a buffer which stores data used for analysis; sampling means which samples part of the clipped data and stores the sampled data in the buffer; analysis data determination means which determines an analysis data group that is a set of the data used for analysis, from the data stored in the buffer; and analysis data output means which transmits the analysis data group to a data analyzing means for analyzing each data.

Although the invention of the present application has been described above with reference to the exemplary embodiments, the invention of the present application is not limited to the above exemplary embodiments. Various changes that can be recognized by those skilled in the art can be made to the configuration and details of the invention of the present application within the scope thereof.

This application claims priority based on Japanese Patent Application No. 2009-038414 filed on Feb. 20, 2009, the disclosure of which is incorporated herein in its entirety.

### INDUSTRIAL APPLICABILITY

The present invention is applied suitably to an analysis preprocessing system which compiles data for analysis collected for the purpose of their analyses.

### REFERENCE SIGNS LIST

1 Time series data generation source
2 Data transmitting means
3 Data receiving means
4 Data stream generating means
5 Time series data analyzing means
7 Analysis preprocessing system
401 Stream data generating means
402 Transmission data buffer
403 Analysis window generating means
404 Stream data transmitting means
406 Sampling means
407 Filtering means
40601 Sample extracting means
40602 Sampling rate setting means
40603 Sampling rate storing means
40605 Sampling rate calculating means
40606 Flow rate monitoring means
40607 Transmission data buffer usage measuring means
40701 Data selecting means
40702 Identity determining means
40711, 40721 Data selecting means
40712, 40722 Effectivity determining means
40713 Effective data defining means
40723 Processed data storing means

1-18. (canceled)

19. An analysis preprocessing system comprising:
a data acquisition unit which acquires a data group generated by a plurality of data generation sources;
a data clipping unit which dips each data from the data group acquired by the data acquisition unit;
a buffer which stores data used for analysis;
a sampling unit which samples part of the clipped data and stores the sampled data in the buffer;
an analysis data determination unit which determines an analysis data group that is a set of the data used for analysis, from the data stored in the buffer; and
an analysis data output unit which transmits the analysis data group to a data analyzing unit for analyzing data.

20. The analysis preprocessing system according to claim 19, wherein the sampling unit samples data at random.

21. The analysis preprocessing system according to claim 19,
wherein the sampling unit includes:
a prediction unit which predicts an amount of data to be given in future from actual results of an amount of data given every predetermined time;
a buffer usage measuring unit which measures usage of the buffer;
a sampling rate calculating unit which calculates a sampling rate, based on the predicted amount of data and the usage of the buffer, and
a sample extracting unit which samples data according to the sampling rate.

22. The analysis preprocessing system according to claim 21,
wherein the sampling rate calculating unit calculates free space of the buffer from the usage of the buffer, and calculates sampling data from a relationship between the number of data storable in the free space and the predicted amount of data.

23. The analysis preprocessing system according to claim 19,
wherein the sampling unit includes:
a sampling rate storing unit which stores a sampling rate input from the outside; and
a sample extracting unit which samples data according to the sampling rate.

24. The analysis preprocessing system according to claim 19, further comprising:
a filtering unit which determines, for each data clipped by the data clipping unit, whether each data satisfies a predetermined condition, inputs each data that satisfies the predetermined condition to the sampling unit, and cancels each data that does not satisfy the predetermined condition.

25. The analysis preprocessing system according to claim 24,
wherein the filtering unit includes:
a contents coincidence/non-coincidence determining unit which determines, for each data clipped by the data clipping unit, whether each data satisfies a condition in which contents of any data already stored in the buffer differ from each other; and
a data selecting unit which cancels each data that does not satisfy the condition and inputs each data that satisfies the condition to the sampling unit.

26. The analysis preprocessing system according to claim 24,
wherein the filtering unit includes:
a reference storing unit which stores a reference indicating that the contents contained in data are effective;
a reference determining unit which determines, for each data clipped by the data clipping unit, whether the contents of each data satisfy the reference; and
a data selecting unit which cancels each data whose contents do not satisfy the reference and inputs each data whose contents satisfy the reference to the sampling unit.

27. The analysis preprocessing system according to claim 24,
wherein the filtering unit includes:
a data identification information storing unit which stores data identification information of each data input from the data clipping unit;
a duplication determining unit which determines, upon receiving each data input from the data clipping unit, whether data identification information of the data is being stored in the data identification information storing unit and, when the data identification information is not stored therein, stores the data identification information of the data in the data identification information storing unit; and
a data selecting unit which cancels data whose data identification information has been determined to be stored in the data identification information storing unit and inputs data whose data identification information has been determined not to be stored in the data identification information storing unit, to the sampling unit.

28. The analysis preprocessing system according to claim 19, further comprising:
a filtering unit which determines, for each data clipped by the data clipping unit, whether each data satisfies a predetermined condition, stores each data that satisfies the predetermined condition in the buffer and cancels each data that does not satisfy the predetermined condition; and
a switching unit which controls to which of the sampling unit and the filtering unit each data clipped by the data clipping unit is input.

29. The analysis preprocessing system according to claim 19,
wherein the analysis data determination unit determines, for every predetermined period, a set of data stored in the buffer within the predetermined period as an analysis data group.

30. The analysis preprocessing system according to claim 19,
wherein the analysis data determination unit determines a set of a predetermined number of data as an analysis data group each time the number of data stored in the buffer reaches the predetermined number.

31. The analysis preprocessing system according to claim 19,
wherein the analysis data output unit deletes each data that belongs to the analysis data group transmitted to the data analyzing unit, from the buffer.

32. The analysis preprocessing system according to claim 19, further comprising data analyzing unit for analyzing data,
wherein the data analyzing unit holds the analysis data group output by the analysis data output unit and deletes an analysis data group after the completion of analysis to thereby perform an analysis asynchronously with the analysis data output unit.

33. An analysis preprocessing method comprising the steps of:
acquiring a data group generated by a plurality of data generation sources;
clipping each data from the acquired data group;
sampling part of the clipped data and storing the sampled data in a buffer;
determining an analysis data group which is a set of data used for analysis, from the data stored in the buffer; and
transmitting the analysis data group to a data analyzing unit for analyzing each data.

34. The analysis preprocessing method according to claim 33, wherein data is sampled at random upon sampling the data.

35. An analysis preprocessing program for causing a computer to execute:
data acquisition processing for acquiring a data group generated by a plurality of data generation sources;
data clipping processing for clipping each data from the data group acquired by the data acquisition processing;
sampling processing for sampling part of the clipped data and storing the sampled data in a buffer;
analysis data determination processing for determining an analysis data group which is a set of data used for analysis, from the data stored in the buffer; and
analysis data output processing for transmitting the analysis data group to a data analyzing unit for analyzing data.

36. The analysis preprocessing program according to claim 35, which causes the computer to perform sampling processing for sampling data at random.
